(19) United States
(12) Patent Application Publication
(10) Pub. No.: US 2010/0030844 A1
(43) Pub. Date: Feb. 4, 2010

(54) Communication System, Information Processing Apparatus, Information Processing Method, and Computer Program

(76) Inventors: Seiji Miyama, Tokyo (JP); Akimichi Ogawa, Kanagawa (JP); Atsushi Onoe, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/030,521

(22) Filed: Feb. 13, 2008

(30) Foreign Application Priority Data
Feb. 15, 2007 (JP) P2007-034367

(51) Int. Cl. G06F 15/16

(52) U.S. Cl. 709/203; 709/231

(57) ABSTRACT

A communication system includes a server that receives broadcast data and outputs the received data to a network-connected client and a client that performs reproduction or recording of the data received from the server. The server includes a broadcast receiving unit that receives the broadcast data and a server-record-scheduling-information managing unit that creates a record scheduling list. The client includes a client-record-scheduling-information managing unit that acquires the record scheduling list from the server and a record processing unit that executes an acquisition request for record-scheduled contents. The server-record-scheduling-information managing unit receives content acquisition request data from the network-connected client, selects request data from plural content acquisition request data overlapping in time, performs a content transmission permission response as a response to the selected request data and transmits requested contents, and performs a response indicating that a request is not executed as a response to the request data not selected.

### CROSS-REFERENCES TO RELATED APPLICATIONS

The present invention contains subject matter related to Japanese Patent Application JP 2007-034367 filed in the Japanese Patent Office on Feb. 15, 2007, the entire contents of which being incorporated herein by reference.

### BACKGROUND OF THE INVENTION

1. Field of the Invention

The present invention relates to a communication system, an information processing apparatus, an information processing method, and a computer program. More particularly, the present invention relates to a communication system in which a server (a network tuner) having a tuner provides a network-connected client with data received by the tuner and the client performs reproduction and recording processing, and an information processing apparatus, an information processing method, and a computer program for the communication system.

2. Description of the Related Art

According to the spread of data communication networks in these days, even in a home, a so-called home network in which home electronics, computers, and peripherals are connected through a network to enable communication among the apparatuses is beginning to spread. The home network enables the network-connected apparatuses to share data processing functions of the apparatuses by performing communication among the apparatuses. The home network provides users with convenience and comfortableness in content transmission and reception and the like among the network-connected apparatuses. Therefore, it is expected that the home network will further spread in future.

It is also possible to deliver broadcast data received by a tuner to network-connected apparatuses such as a PC and a display through such a home network and reproduce broadcast contents in the apparatuses located in places different from a place where the tuner is located.

In these days, most of AV contents including broadcast contents are provided in digital forms. Since illegal operation such as copy and manipulation of the digitized contents is relatively easy, measures against such illegal use is necessary while allowing personal use and home use of the contents. Many techniques for the purpose of protection of copyright of digital contents have been developed. For example, as an industrial standard concerning protection of digital transmission contents, there is a DTCP (Digital Transmission Content Protection) standard developed by DTLA (Digital Transmission Licensing Administrator). In the DTCP standard, a mechanism for transmitting contents with copyright thereof protected is prescribed (see, for example, Digital Transmission Content Protection Specification Volume 1 (Informational Version), Revision 1.4 (http://www.dtcp.com)).

In the DTCP standard, an authentication protocol among apparatuses during content transmission and a transmission protocol for encrypted contents are decided. As rules for the protocols, in short, it is decided that, for example, a DTCP compliant apparatuses should not transmit easy-to-handle compressed contents such as MPEG (Moving Picture Experts Group) contents to the outside in an unencrypted state, key exchange necessary for decoding encrypted contents should be performed in accordance with predetermined mutual authentication and key exchange (Authentication and Key Exchange: AKE) algorithms, and a range of apparatuses that perform key exchange according to an AKE command should be limited.

A server (a DTCP Source) as a content provision source and a client (a DTCP Sink) as a content provision destination share a key through an authentication procedure according to transmission and reception of the AKE command, encrypt a transmission path using the key, and transmit contents. Therefore, since it is difficult for an illegal client to acquire an encryption key unless the client succeeds in authentication with the server, the client may be unable to receive the contents. It is possible to limit a range in which the contents are used to a range of personal or home use referred to in the Copyright Law by limiting the number and a range of apparatuses that transmit and receive the AKE command.

Originally, the DTCP standard defines transmission of digital contents on a home network employing IEEE 1394 or the like for a transmission path. However, recently, as represented by the DLNA (Digital Living Network Alliance), the movement for circulating digitized AV contents in a home using an IP network is started in earnest. Therefore, a DTCP technique applicable to the IP network, i.e., a DTCP-IP (DTCP over IP) standard for realizing, using an IP packet, content circulation conforming to the DTCP standard is proposed. It is expected that apparatuses conforming to this standard will be a mainstream of home network apparatuses in future.

In most of home networks, when the home networks are connected to an external IP network such as the Internet through routers or the like, misgivings about illegal copy and manipulation of contents are pointed out. However, through the establishment of a DTCP-IP technique, flexible and efficient use of contents employing the IP network is realized while digital contents are protected.

The DTCP-IP standard is basically included in the DTCP standard and is a technique realized by importing the DTCP technique into the IP network. The DTCP-IP standard prescribes the use of the IP network for a transmission path, a protocol applied to transmission of encrypted contents, and the like. Various apparatuses such as PCs are connected on the IP network and it is highly likely that tapping and manipulation of data are easily performed. Therefore, the DTCP-IP standard has detailed rules for performing network transmission while protecting contents (see, for example, DTCP Volume 1 Supplement E Mapping DTCP to IP (Informational Version), Revision 1.1 (http://www.dtcp.com)).

Content transmission conforming to the DTCP-IP standard is explained. For example, content transmission is carried out using an HTTP protocol between a source apparatus and a sink apparatus conforming to the DTCP-IP standard. The source apparatus is, for example, a server that provides contents. The sink apparatus is, for example, a client that receives the contents from the server. Encrypted communication of a large byte stream such as a TCP (Transmission Control Protocol) stream is performed between the source apparatus and the sink apparatus while a content key is changed during transmission. When content processing such as decoding processing for encrypted contents is carried out, a procedure for checking a content key is performed. TCP connection is established every time procedure for mutual authentication and key exchange (AKE), content transmission, or content key check is performed.

Specifically, when the AKE procedure is successful, the source (DTCP_Source) apparatus and the sink (DTCP_Sink) apparatus can share an authentication key Kₐᵤₜₕ. Each of the source apparatus and the sink apparatus performs same processing in the inside thereof to generate a seed key Kₓ as a seed of a content key from the authentication key Kₐᵤₜₕ. The source apparatus generates a nonce N_{c} using a random number and generates a content key K_{c} on the basis of Kₓ and N_{c}. The source apparatus encrypts contents requested by the sink apparatus using the content key K_{c} and transmits a packet including the encrypted contents and the nonce N_{c} to the sink apparatus on a TCP stream. On the other hand, when the sink apparatus extracts the nonce N_{c} from the TCP stream, the sink apparatus can calculate the content key K_{c} in the same manner using the nonce N_{c} and the key Kₓ calculated from the authentication key Kₐᵤₜₕ and decode the encrypted contents.

In this way, the DTCP-IP standard can provide a safest content transmission method or the IP network for preventing tapping and manipulation of contents in a course of the transmission path by performing authentication between apparatuses conforming to the DTCP standard, sharing a key between the apparatuses for which the DTCP authentication is completed, and encrypting and decoding the contents in transmitting the contents.

For example, when contents are requested in accordance with a procedure of HTTP, the DTCP_Source acts as an HTTP server and theDTCP_Sink acts as an HTTP client. The HTTP client creates TCP/IP connection for HTTP and starts transmission of the contents. The HTTP client requests contents on the HTTP server according to an operation procedure completely the same as the normal HTTP. On the other hand, the HTTP server returns the contents as requested as an HTTP response. The HTTP server encrypts the contents requested by the HTTP client using the content key Kc and transmits a packet (PCT: Protected Content Packet (see, for example, JP-A-2000-287192)) formed by a payload including the encrypted contents and a header including the nonce Nc to the HTTP client on the TCP stream.

A home network including one network tuner as a server that receives a broadcast wave and delivers the broadcast wave to a network in streaming and plural record clients that receive delivered data of the network tuner through the network and accumulate the data in local storages is assumed. The respective clients apply record schedulings for various programs on various channels to the network tuner as the server. The network tuner receives these record schedulings and executes tuning of tuners and processing for providing the clients with received contents in accordance with record scheduling information.

However, when the network tuner has only one tuner, even if record schedulings for programs on different channels are performed in the same time frame, only processing for one record scheduling can be executed. The clients are capable of freely perform record schedulings. Therefore, it is likely that record schedulings overlap. As forms of the overlap, there are various forms, for example, record times of plural different programs completely overlap or parts of time frames of plural record schedulings overlap.

When start times of programs record-scheduled by the clients are close, the clients transmit program reception requests to the network tuner. The clients transmit, for example, HTTP GETs in which URLs corresponding to the programs are set to the network tuner. According to reception of HTTP GETs, the network tuner performs processing for executing channel tuning corresponding to designated programs and transmitting received contents to the clients.

As a management configuration for record scheduling information, two methods are conceivable, i.e., an individual management configuration in the clients and a collective management configuration in the network tuner as the server. When there is only one client, for example, even if different program schedulings are performed in an identical time frame in the client, it is possible to determine one record execution program out of record schedulings competing with one another in accordance with an algorithm executed in the client and perform a program reception request for the determined one program.

However, in a network in which plural clients are present, when the respective clients individually manage record scheduling information, program reception requests are transmitted from the respective clients to the network tuner. Therefore, the network tuner needs to execute an original selection algorithm of the tuner and determine one recorded program. In other words, the respective clients and the network tuner need to individually execute processing for selecting a recorded program. As a result, a processing load increases and the client may be unable to learn which program is actually recorded. In such a case, it is likely that the respective clients continuously execute processing for transmitting HTTP GETs in which URLs corresponding to programs record-scheduled by the clients themselves are set to the network tuner.

As a specific example, an example of processing performed when parts of record scheduling times set by the respective clients overlap is explained. When a program “a” (broadcast time: 16:00 to 17:00) record-scheduled by one client A is selected and recording is executed, recording of a program “b” (broadcast time: 16:00 to 17:30) record-scheduled by another client B may be possible after the end of the program “a” (17:00). However, the client B has no means for learning when the recording of the program “a” by the client A is finished. In order to surely execute the recording of the program “b” after the end of the program “a” (17:00), the client B has to repeatedly transmit a program reception request (HTTP GET) corresponding to the program “b” to the network tuner from start time of the program “b”.

### SUMMARY OF THE INVENTION

Therefore, it is desirable to provide a communication system that provides network-connected clients with broadcast contents received by a network-connected network tuner having a tuner function and performs reproduction and recording of the broadcast contents and an information processing apparatus, an information processing method, and a computer program for the communication system. In the communication system, the network tuner collectively manages record scheduling information of the respective clients and provides the clients with information based on the record scheduling information, whereby it is possible to execute record processing without causing the clients to perform unnecessary processing.

According to an embodiment of the present invention, there is provided a communication system including:

a server that receives broadcast data and outputs the received data to a network-connected client; and

a client that performs reproduction or recording of the data received from the server, wherein

the server includes:
a broadcast receiving unit that receives the broadcast data; and
a server-record-scheduling-information managing unit that creates a record scheduling list based on record scheduling information inputted from the client,

the client includes:
a client-record-scheduling-information managing unit that acquires the record scheduling list from the server; and
a record processing unit that executes an acquisition request for record-scheduled contents on the basis of the record scheduling information recorded in the record scheduling list, and

the server-record-scheduling-information managing unit receives content acquisition request data from the network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

It is preferable that the record processing unit of the client transmits a content acquisition request to the server on the basis of start scheduled time information of respective record-scheduled programs included in record scheduling information as recording data of the record scheduling list, and the server-record-scheduling-information managing unit determines, by executing a selection algorithm set in advance, whether content transmission corresponding to the content acquisition request from the client should be executed.

It is preferable that the server-record-scheduling-information managing unit transmits, when the record scheduling list is updated, an update notice indicating that the record scheduling list is updated to the client.

It is preferable that the server further includes an information-update monitoring unit that judges whether it is necessary to update the record scheduling list on the basis of a change in a broadcast time of broadcast contents, and the server-record-scheduling-information managing unit performs, on the basis of judgment of the information-update monitoring unit that it is necessary to update the record scheduling list, processing for updating the record scheduling list.

It is preferable that the server-record-scheduling-information managing unit records, in the record scheduling list, broadcast start time information of a record-scheduled program and record execution start time information determined by the server.

It is preferable that the record processing unit of the client executes processing for determining timing for output of a content acquisition request to the server on the basis of the record execution start time information recorded in the record scheduling list.

It is preferable that the server further includes a server-time-information managing unit that stores and manages present time information received by the broadcast receiving unit, and the server-record-scheduling-information managing unit records the present time information acquired by the server-time-information managing unit in the record scheduling list and provides the client with the present time information.

It is preferable that the client further includes a client-time-information managing unit that calculates a difference between present time of the present time information recorded in the record scheduling list and time of a clock provided in the client, and the record processing unit of the client performs processing for determining execution timing of record processing on the basis of time information corresponding to a record-scheduled program recorded in the record scheduling list and difference information provided from the client-time-information managing unit.

It is preferable that the server further includes a timestamp managing unit that determines a value of a timestamp set in data transmitted to the client, the client further includes a client-encryption processing unit that performs processing for decoding data received from the server and holds a value of a timestamp of data stored in a storing unit, and the record processing unit of the client applies, in outputting a content transmission request after suspension of communication with the server, the value of the timestamp held by the client-encryption processing unit, determines a value of a timestamp set in data at the time of content transmission resumption in the server as a start timestamp value, and executes processing for notifying the server of the start timestamp value.

It is preferable that the timestamp managing unit of the server performs, on the basis of the start timestamp value included in the data received from the client, processing for determining a value of a timestamp set in transmission data after the suspension of the communication.

According to another embodiment of the present invention, there is provided an information processing apparatus as a server that receives broadcast data and outputs the received data to a network-connected client, the information processing apparatus including:

a broadcast receiving unit that receives broadcast data; and

a server-record-scheduling-information managing unit that creates a record scheduling list based on record scheduling information inputted from the client, wherein
the server-record-scheduling-information managing unit receives content acquisition request data from a network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

It is preferable that the server-record-scheduling-information managing unit determines, by executing a selection algorithm set in advance, whether content transmission corresponding to the content acquisition request from the client should be executed.

It is preferable that the server-record-scheduling-information managing unit transmits, when the record scheduling list is updated, an update notice indicating that the record scheduling list is updated to the client.

It is preferable that the information processing apparatus further includes an information-update monitoring unit that judges whether it is necessary to update the record scheduling list on the basis of a change in a broadcast time of broadcast contents, and the server-record-scheduling-information managing unit performs, on the basis of judgment of the information-update monitoring unit that it is necessary to update the record scheduling list, processing for updating the record scheduling list.

It is preferable that the server-record-scheduling-information managing unit records, in the record scheduling list, broadcast start time information of a record-scheduled program and record execution start time information determined by the server.

It is preferable that the information processing apparatus further includes a server-time-information managing unit that stores and manages present time information received by the broadcast receiving unit, and the server-record-scheduling-information managing unit records the present time information acquired by the server-time-information managing unit in the record scheduling list and provides the client with the present time information.

It is preferable that the information processing apparatus further includes a timestamp managing unit that determines a value of a timestamp set in data transmitted to the client, and the timestamp managing unit performs, on the basis of a start timestamp value included in data received from the client, processing for determining a value of a timestamp set in transmission data after the suspension of the communication.

According to still another embodiment of the present invention, there is provided an information processing apparatus as a client that receives broadcast data received by a server and performs reproduction or recording of the received data, the information processing apparatus including:

a client-record-scheduling-information managing unit that acquires a record scheduling list, which is created by the server on the basis of record scheduling information inputted from the client, from the server; and

a record processing unit that executes an acquisition request for record-scheduled contents on the basis of the record scheduling information recorded in the record scheduling list, wherein

the record processing unit transmits a content acquisition request to the server on the basis of start scheduled time information of respective record-scheduled programs included in record scheduling information as recording data of the record scheduling list.

It is preferable that the record scheduling list created by the server has broadcast start time information of a record-scheduled program and record execution start time information determined by the server recorded therein, and the record processing unit executes processing for determining timing for output of a content acquisition request to the server on the basis of the record execution start time information recorded in the record scheduling list.

It is preferable that the record scheduling list created by the server has present time information received by a broadcast receiving unit of the server recorded therein, the information processing apparatus includes a client-time-information managing unit that calculates a difference between present time of present time information recorded in the record scheduling list and time of a clock provided in the client, and the record processing unit performs processing for determining execution timing of record processing on the basis of time information corresponding to a record-scheduled program recorded in the record scheduling list and difference information provided from the client-time-information managing unit.

It is preferable that the information processing apparatus further includes a client-encryption processing unit that performs processing for decoding data received from the server and holds a value of a timestamp of data stored in a storing unit, and the record processing unit applies, in outputting a content transmission request after suspension of communication with the server, the value of the timestamp held by the client-encryption processing unit, determines a value of a timestamp set in data at the time of content transmission resumption in the server as a start timestamp value, and executes processing for notifying the server of the start timestamp value.

According to still another embodiment of the present invention, there is provided an information processing method executed in an information processing apparatus as a server that receives broadcast data and outputs the received data to a network-connected client, the information processing method including:

a broadcast receiving step in which a broadcast receiving unit receives broadcast data;

a step in which a server-record-scheduling-information managing unit creates a record scheduling list based on record scheduling information inputted from the client; and

a step in which the server-record-scheduling-information managing unit receives content acquisition request data from a network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

According to still another embodiment of the present invention, there is provided an information processing method executed in an information processing apparatus as a client that receives broadcast data received by a server and performs reproduction or recording of the received data, the information processing method including:

a record-scheduling-information managing step in which a client-record-scheduling-information managing unit acquires a record scheduling list, which is created by the server on the basis of record scheduling information inputted from the client, from the server; and

a record processing step in which a record processing unit executes an acquisition request for record-scheduled contents on the basis of the record scheduling information recorded in the record scheduling list, wherein

the record processing step includes a step of transmitting a content acquisition request to the server on the basis of start scheduled time information of respective record-scheduled programs included in record scheduling information as recording data of the record scheduling list.

According to still another embodiment of the present invention, there is provided a computer program that causes an information processing apparatus as a server that receives broadcast data and outputs the received data to a network-connected client to execute information processing, the computer program causing the information processing apparatus to execute:

a broadcast receiving step of causing a broadcast receiving unit to receive broadcast data;

a step of causing a server-record-scheduling-information managing unit to create a record scheduling list based on record scheduling information inputted from the client; and

a step of causing the server-record-scheduling-information managing unit to receive content acquisition request data from the network-connected client, select request data, for which content transmission processing is executed, from plural content acquisition request data overlapping in time, perform a content transmission permission response as a response to the selected request data and transmit requested contents, and perform a response indicating that a request is not executed as a response to the request data not selected.

According to still another embodiment of the present invention, there is provided a computer program for causing an information processing apparatus as a client that receives broadcast data received by a server and performs reproduction and recording of the received data to execute information processing, the computer program causing the information processing apparatus to execute:

a record-scheduling-information managing step of causing a client-record-scheduling-information managing unit to acquire a record scheduling list, which is created by the server on the basis of record scheduling information inputted from the client, from the server; and

a record processing step of causing a record processing unit to execute an acquisition request for record-scheduled contents on the basis of the record scheduling information recorded in the record scheduling list, wherein
the record processing step includes a step of causing the information processing apparatus to transmit a content acquisition request to the server on the basis of start scheduled time information of respective record-scheduled programs included in record scheduling information as recording data of the record scheduling list.

The computer programs according to the embodiments of the present invention are computer programs that can be provided to, for example, a computer system, which can execute various program codes, by means of recording media provided in a computer-readable format or communication mediums, for example, recording media such as a CD, an FD, and an MO or communication media such as a network. By providing such programs in the computer-readable format, processing corresponding to the programs is realized on the computer system.

Other objects, characteristics, and advantages of the present invention will be made apparent by more detailed explanation based on embodiments of the present invention described later and drawings attached hereto. A system in this specification is a logical set of plural apparatuses and is not limited to a system in which apparatuses of respective structures are provided in an identical housing.

According to an embodiment of the present invention, in a communication system including a server that receives broadcast data and outputs the received data to a network-connected client and a client that performs reproduction or recording of the data received from the server, the server creates a record scheduling list based on record scheduling information inputted from the client and provides the client with the record scheduling list. The client executes an acquisition request for record-scheduled contents on the basis of the record scheduling information recorded in the record scheduling list. The server selects request data, for which content transmission processing is executed, from plural content acquisition request data overlapping in time, performs a content transmission permission response as a response to the selected request data and transmits requested contents, and performs a response indicating that a request is not executed as a response to the request data not selected. Therefore, the client only performs a content transmission request based on record scheduling set by the client itself without performing selection processing and the like for contents overlapping in time. Consequently, a processing load is reduced.

According to another embodiment of the present invention, record execution time determined by the server and present time information received by the broadcast receiving unit are recorded in record scheduling information and provided to the client. Therefore, an accurate content acquisition request based on these kinds of information is realized in the client.

According to still another embodiment of the present invention, it is possible to notify the server determined by the client of a value of a timestamp set by the server when suspension of communication or the like occurs between the server and the client. Therefore, continuity of timestamps is maintained and it is unnecessary to rewrite the set timestamp when the client acts as a server and transmits data. Consequently, a processing load is reduced.

### BRIEF DESCRIPTION OF THE DRAWINGS

FIG. 1 is a diagram for explaining a network environment to which an information processing apparatus according to an embodiment of the present invention is applicable;

FIG. 2 is a diagram for explaining an example of the structure of a network tuner according to a first embodiment of the present invention;

FIG. 3 is a diagram for explaining an example of the data structure of a CDS Browse request, which is a record scheduling list browse request, outputted from a client to the network tuner;

FIG. 4 is a diagram for explaining an example of the data structure of record scheduling list information provided to the client by the network tuner as a response to the CDS Browse request, which is the record scheduling list browse request, outputted from the client to the network tuner;

FIG. 5 is a diagram for explaining an example of display data displayed on a display unit of the client on the basis of a record scheduling list;

FIG. 6 is a diagram for explaining a processing sequence in starting recording based on a record scheduling list;

FIG. 7 is a diagram showing a time chart representing a relation between a change in a response of the network tuner to content transmission requests (HTTP GETs) from clients and time;

FIG. 8 is a diagram for explaining an example of the structure of a network tuner according to a second embodiment of the present invention;

FIG. 9 is a diagram for explaining an example of record execution for record schedulings overlapping in recording time;

FIG. 10 is a diagram showing an example of a record scheduling list presented to a client in response to reception of a record scheduling list browse request (CDS Browse);

FIG. 11 is a diagram for explaining an example of processing performed when broadcast time of a program is changed on account of a broadcasting station's schedule;

FIG. 12 is a diagram for explaining the example of processing performed when broadcast time of a program is changed on account of a broadcasting station's schedule;

FIG. 13 is a diagram for explaining an example of the structure of a network turner according to a third embodiment of the present invention;

FIG. 14 is a diagram for explaining a processing sequence in which a client that executes recording receives a record scheduling list from the network tuner and an example of the data structure of the record scheduling list;

FIG. 15 is a diagram for explaining an example of the structure of MPEG2-TTS;

FIG. 16 is a diagram for explaining an example of the structure of a network tuner according to a fourth embodiment of the present invention; and

FIG. 17 is a diagram for explaining a processing sequence by transmission of a record streaming request in which a start timestamp value is recorded and an example of the data structure of record streaming request data.

### DESCRIPTION OF THE PREFERRED EMBODIMENTS

An information processing apparatus, an information processing method and a computer program according to embodiments of the present invention will be hereinafter explained with reference to the accompanying drawings. The embodiments are explained in accordance with items described below.

1. Example of a network configuration

2. Configuration for record scheduling information management and information provision processing in a network tuner

3. Control of record execution start time in a client based on a record scheduling list

4. Time information management in record processing

5. Control of a timestamp

[1. Example of a Network Configuration]

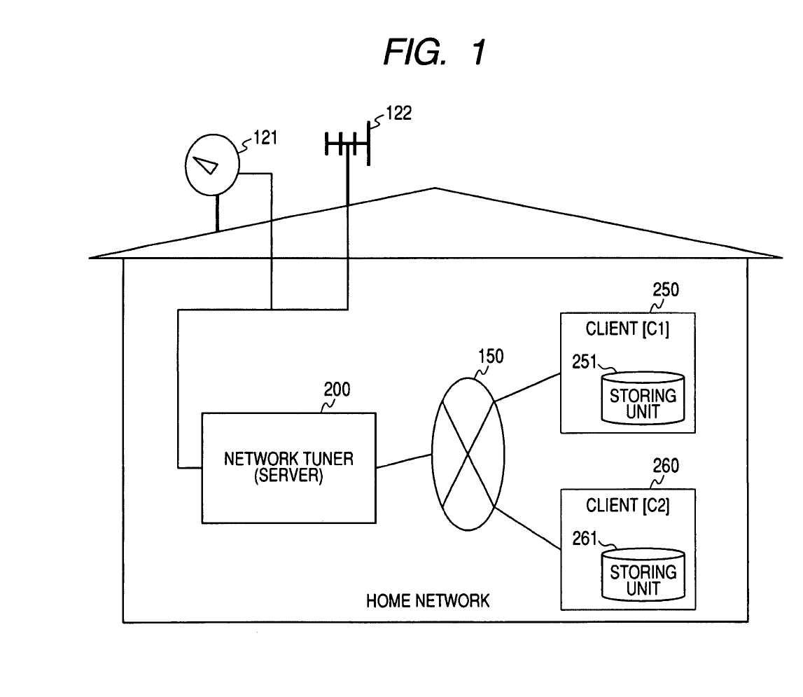

First, a network environment to which an information processing apparatus according to an embodiment of the present invention is applicable is explained with reference to FIG. 1. FIG. 1 shows a home network configuration in which various information processing apparatuses are connected to one another. A network tuner 200 incorporates a TV tuner, receives a satellite broadcast and a terrestrial broadcast through antennas 121 and 122, and provides clients 250 and 260 with received broadcast contents through a network 150. The clients 250 and 260 receive the broadcast contents, which are received by the network tuner 200, from the network tuner 200 and record the broadcast contents in storing units 251 and 261 of the clients 250 and 260 including hard disks. This record processing is executed on the basis of, for example, record scheduling. Although two clients are shown in FIG. 1, a larger number of clients may be connected to the network.

The network 150 shown in FIG. 1 is, for example, an IP (Internet Protocol) network. Transmission of digital contents through the network 150 is executed in accordance with the DTCP-IP (DTCP over IP) standard. In the transmission of digital contents conforming to the DTCP-IP standard, as explained above, for example, after authentication processing between a server (a source) on a content provision side and a client (a sink) on a content reception side, the server encrypts and transmits contents and the client decodes the received encrypted contents and executes reproduction processing. TCP connection is established between the server and the client and processing is executed every time the series of processing is performed, i.e., every time a procedure of mutual authentication and key exchange (AKE), content transmission, and content key check is performed.

Contents are encrypted using a content key and transmitted on a TCP (Transmission Control Protocol) stream as a packet (PCP: Protected Content Packet) formed by a payload including the encrypted contents and a header including content key generation information (a nonce N). When the network tuner 200 shown in FIG. 1 receives the broadcast contents through the antennas 121 and 122 and provides the clients 250 and 260 with the received contents, the network tuner 200 performs encryption processing and PCP generation for the received contents and outputs the received contents.

[2. Configuration for Record Scheduling Information Management and Information Provision Processing in a Network Tuner]

In the network in which the one network tuner (server) 200 and the plural clients 250 and 260 are present as shown in FIG. 1, the clients 250 and 260 can independently perform record schedulings and output program acquisition requests based on the record schedulings (HTTP GETs in which URLs corresponding to specific programs are set) to the network tuner 200.

However, as explained above, in the network environment in which the plural clients 250 and 260 are present as shown in FIG. 1, when program reception requests received by the network tuner 200 from the respective clients 250 and 260 are requests for receiving programs overlapping in an identical time frame of different channels, the network tuner 200 needs to select a program for which recording is executed. In this case, the clients 250 and 260 may be unable to learn, for example, whether recording of record-scheduled programs of the clients 250 and 260 is executed. At least one of the clients 250 and 260 may be unable to receive the program requested by the client. Therefore, the client has to continuously transmit HTTP GET in which a URL corresponding to the record-scheduled program of the client to the network tuner 200 is set.

In order to solve such a problem, the network tuner 200 shown in FIG. 1 collectively manages record scheduling information of the respective clients 250 and 260 and provides the clients 250 and 260 with information based on the record scheduling information. Consequently, record processing that does not cause unnecessary processing in the client is realized.

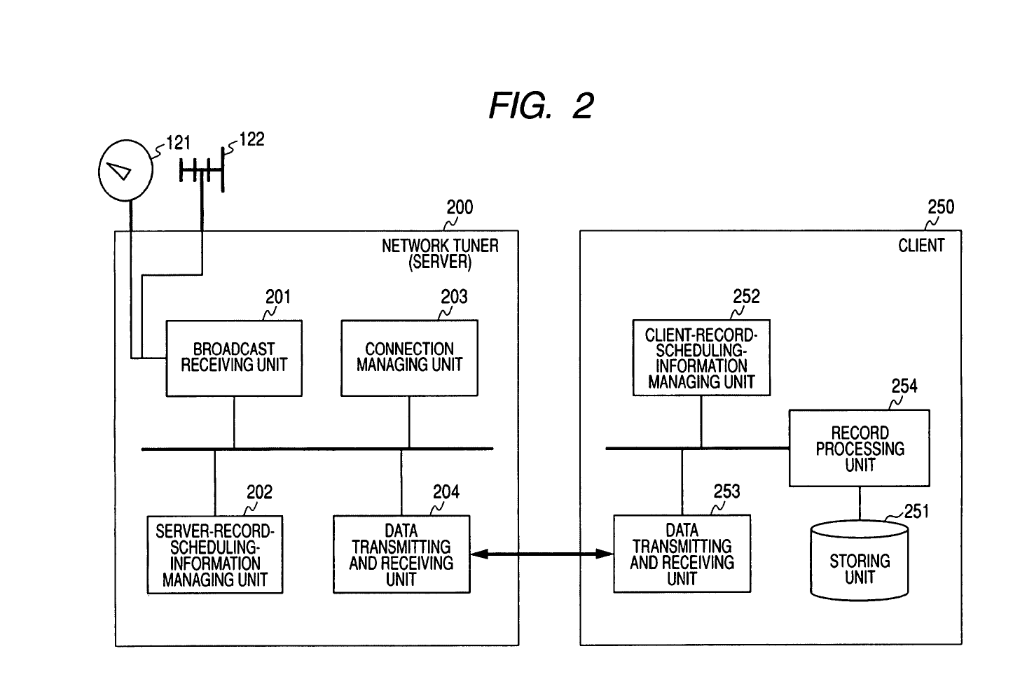

An example of the structure of the network tuner (the server) 200 and the client 250 that constitute the communication system according to a first embodiment is explained with reference to FIG. 2. In FIG. 2, an example of the structure of one client 250 is shown. However, other clients have the same structure.

The network tuner 200 includes, as shown in FIG. 2, a broadcast receiving unit 201, a server-record-scheduling-information managing unit 202, a connection managing unit 203, and a data transmitting and receiving unit 204. The broadcast receiving unit 201 receives broadcast data through the antennas 121 and 122, extracts broadcast contents (MPEG data) corresponding to a tuned-in channel, and outputs the broadcast contents to the data transmitting and receiving unit 204. The data transmitting and receiving unit 204 outputs the received data to the client 250. The outputted data is, for example, a record-scheduled program. Program provision processing is executed on the basis of reception of HTTP GET in which a URL corresponding to the program outputted from the client 250 is set.

The server-record-scheduling-information managing unit 202 collectively manages record scheduling information from respective clients connected to a network, for example, in the example shown in FIG. 1, the clients 250 and 260. Specifically, the server-record-scheduling-information managing unit 202 creates a record scheduling list based on the record scheduling information from the respective clients and provides the client 250 with the created record scheduling list on the basis of a request (a CDS Browse request) from the client 250. The connection managing unit 203 executes management of communication connection with the client 250 and the other clients.

The network tuner 200 as a server that provides the clients with contents stores a record scheduling list, which is based on program information corresponding to broadcast contents received through the broadcast receiving unit 201 and record scheduling information from the respective clients, in a not-shown storing unit and manages the record scheduling list. This data management is executed by applying, for example, a CDS (Content Directory Service) defined in the UPnP (Universal Plug and Play) that prescribes home network specifications.

The server-record-scheduling-information managing unit 202 is inputted with the record scheduling information from the respective clients, creates a record scheduling list, and manages, by applying a CDS, the record scheduling list created on the basis of the record scheduling information from the clients using a directory of a logical hierarchical structure. The respective clients connected to the network are capable of performing browse requests for various kinds of information managed by the CDS. The browse requests are called CDS Browse. The server-record-scheduling-information managing unit 202 outputs the record scheduling list to the clients when CDS Browse, which is the browse requests for the record scheduling list from the clients, is received.

When data managed by the CDS is updated, transmission of GENA Notify as notification processing for notifying the clients of information change and update is executed. For example, when one of the clients performs program record scheduling and the record scheduling list managed by the server-record-scheduling-information managing unit 202 is changed, the respective clients can learn the change from the notification processing (GENA Notify). The clients can also output CDS Browse as browse requests for the record scheduling list in response to the notification.

The structure of the client 250 shown in FIG. 2 is explained. As shown in the figure, the client 250 includes a storing unit 251 that records, for example, a recorded program, a client-record-scheduling-information managing unit 252 that manages record scheduling information in the client, a data transmitting and receiving unit 253 that executes data communication with the network tuner (the server) 200, and a record processing unit 254 that executes record processing.

Besides the management of the record scheduling information in the client and the processing for outputting the record scheduling information to the network tuner 200, the client-record-scheduling-information managing unit 252 executes processing for transmitting the browse request (CDS Browse) to the network tuner 200 and acquiring a record scheduling list created by the network tuner 200. The record processing unit 254 judges, on the basis of information acquired from the client-record-scheduling-information managing unit 252, specifically, the record scheduling information in the client and information concerning the record scheduling list acquired from the network tuner 200, time when record processing can be started. The record processing unit 254 transmits HTTP GET in which a URL corresponding to a record-scheduled program is set to the network tuner 200 through the data transmitting and receiving unit 253.

The network tuner 200 transmits [status code OK], which is a status code indicating that it is possible to transmit information, to the client as a response to HTTP GET. After receiving the status code from the network tuner 200, the client 250 starts reception of broadcast contents, stores the broadcast contents in the storing unit 251, and executes record processing.

Overviews of main processing of the network tuner 200 and the client 250 shown in FIG. 2 are collectively explained. The network tuner 200 receives record scheduling from the client 250, creates a record scheduling list, manages the record scheduling list in the CDS, and provides the client 250 with the record scheduling list in response to a request (CDS Browse) from the client 250.

The client 250 judges recording start time of the client 250 itself on the basis of its own record scheduling information and the record scheduling list and transmits an acquisition request (HTTP GET) for a recorded program to the network tuner 200. When it is possible to provide broadcast contents in response to the request from the client 250, the network tuner 200 notifies the client 250 of [status code OK] indicating that it is possible to transmit information. Then, the network tuner 200 outputs the recorded program to the client 250. When it is difficult to respond to the acquisition request (HTTP GET) for the recorded program from the client 250 because of overlapping record scheduling or the like, the network tuner 200 outputs [HTTP 503 Service Unavailable], which is a status code indicating that it is difficult to perform information provision processing corresponding to HTTP GET, to the client 250.

The main processing executed by the network tuner 200 is as described below.

(A) Processing for holding a record scheduling list and judging which record scheduling should be given priority when record schedulings overlap.

(B) Processing for outputting record scheduling list information in response to a CDS Browse request from the client 250.

The main processing executed by the client 250 that receives broadcast data from the network tuner 200 and records the broadcast data is as described below.

(A) Processing for transmitting a CDS Browse request to the network tuner 200 and acquires record scheduling list information managed by the network tuner 200.

(B) Processing for extracting record scheduling, for which the client 250 should execute recording, from a result of CDS Browse.

(C) Processing for calculating, from the result of CDS Browse, time when the client 250 acquires recorded video data from the server.

(D) Processing for transmitting HTTP GET for receiving broadcast data on the basis of the record scheduling list information outputted from the network tuner 200.

These kinds of processing are the main processing executed by the network tuner 200 and the client 250.

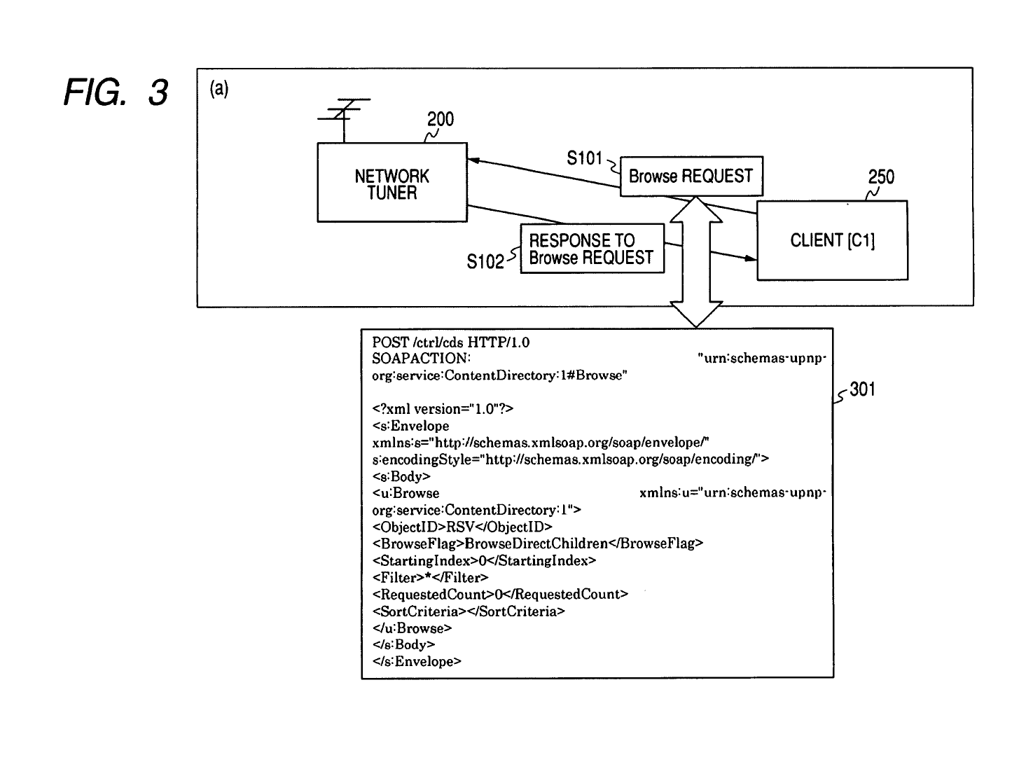

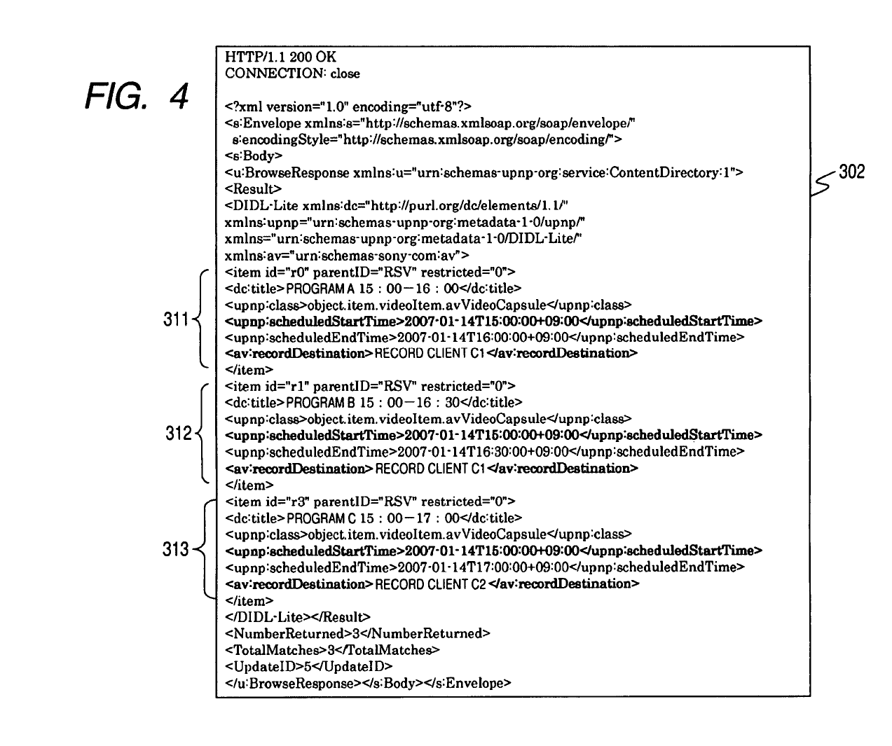

A CDS Browse request, which is a record scheduling list browse request outputted from the client 250 to the network tuner 200, and an example of the data structure of record scheduling list information provided to the client 250 by the network tuner 200 are explained with reference to FIGS. 3 and 4. (a) in FIG. 3 shows a communication processing sequence between the client 250 and the network tuner 200 for executing browse processing for a record scheduling list. First, in step S101, the client 250 transmits a CDS Browse request to the network tuner 200. The network tuner 203 receives the CDS Browse request and presents a record scheduling list as a response to the CDS Browse request.

Data 301 shown in FIG. 3 is an example of the data structure of CDS Browse request data 301, which is a record scheduling list browse request outputted from the client 250. The record scheduling list browse request data 301 shown in the figure is an example of record scheduling list browse request data for record scheduling list browse performed by using a SOAP (Simple Object Access Protocol) action defined as one kind of message communication processing between network apparatuses in the UPnP.

The server-record-scheduling-information managing unit 202 of the network tuner 200 receives the browse request data 301 and outputs a record scheduling list 302 shown in FIG. 4 to the client 250 as a response to the browse request.

The record scheduling list 302 shown in FIG. 4 is a record scheduling list created by the server-record-scheduling-information managing unit 202 of the network tuner 200 on the basis of record scheduling information from the respective clients. Record scheduling information from the network-connected clients is recorded in the record scheduling list 302. For example, record data 311, 312, and 313 are record scheduling data corresponding to individual kinds of record scheduling information, respectively, as described below.

(1) Record Scheduling Data 311

Record scheduling for a program A (broadcast time: 2007 Jan. 14, 15:00 to 16:00) by a client [C1]

(2) Record Scheduling Data 312

Record scheduling for a program B (broadcast time: 2007 Jan. 14, 15:00 to 16:30) by the client [C1]

(3) Record Scheduling Data 313

Record scheduling for a program C (broadcast time: 2007 Jan. 14, 15:00 to 17:00) by a client [C2]

In this way, the record scheduling list held by the network tuner 200 is set as a list in which all kinds of record scheduling information from the respective clients are recorded. The record scheduling list is presented in response to a browse (CDS Browse) request from the client 250.

[av:recordDestination] in respective record scheduling data 311 to 313 included in the record scheduling list 302 indicates a recording destination client. In the example shown in the record scheduling list 302, the record client [C1] is set as a recording destination for the program A and the program B and the record client [C2] is set as a recording destination for the program C.

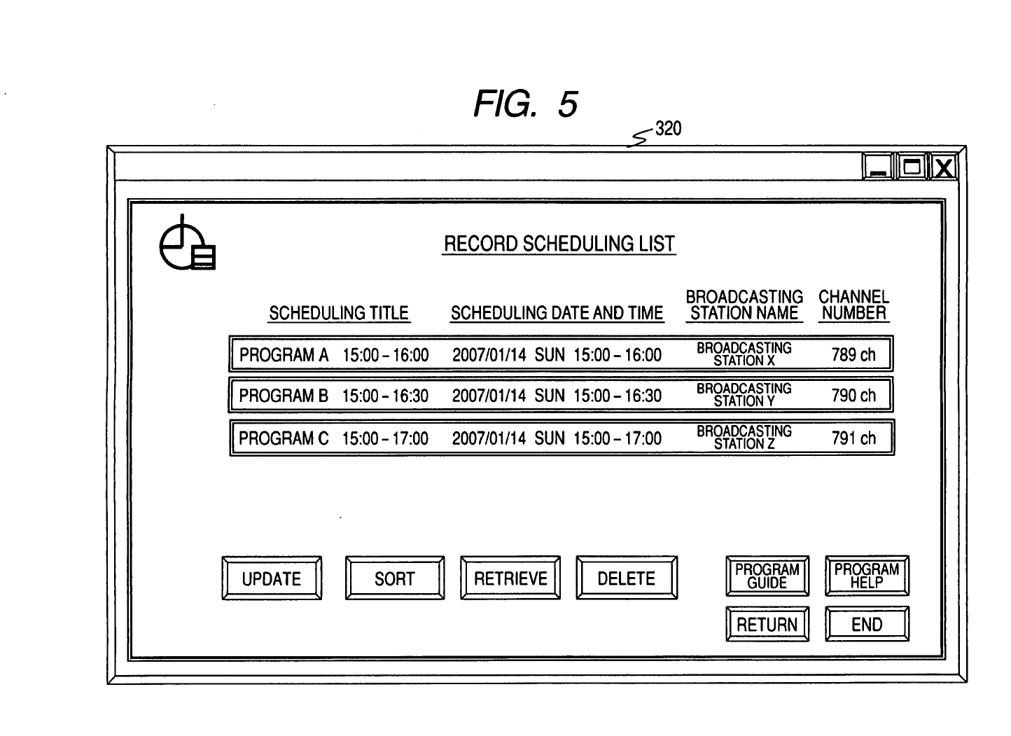

For example, when the client 250 acquires a record scheduling list from the network tuner 200, the client 250 can output the acquired scheduling list to a screen. Acquisition and management of the record scheduling list are performed by the client-record-scheduling-information managing unit 252 of the client 250 shown in FIG. 2. When the client-record-scheduling-information managing unit 252 inputs a record scheduling list display request through an input unit (not shown), data display based on the record scheduling list 302 shown in FIG. 4 is performed. For example, the client-record-scheduling-information managing unit 252 generates display data 320 shown in FIG. 5 on the basis of the record scheduling list 302 and outputs the display data 320 to the display unit (the display). The display data 320 is displayed as a list of record scheduling states from the respective clients included in the record scheduling list 302 shown in FIG. 4.

The record processing unit 254 of the client 250 outputs an acquisition request for a recorded program to the network tuner 200 on the basis of the record scheduling list 302 shown in FIG. 4. For example, when the network tuner 200 receives HTTP GET as a content acquisition request of a record executing client from two minutes before record starting time, the client 1, which has performed record scheduling for the programs A and B having program start time 15:00 in the record scheduling list 302, transmits HTTP GETs as content acquisition requests corresponding to the programs A and B. The client 2, which has performed record scheduling for the program C having program start time 15:00 in the record scheduling list 302, transmits HTTP GET as a content acquisition request corresponding to the program C. Transmission timing of HTTP GET is set according to reception start time of the network tuner 200. For example, when reception setting from two minutes before the reception start time is performed, HTTP GET for broadcast data reception only has to be transmitted after two minutes before program start scheduled time, i.e., after 14:58.

In this embodiment, the respective clients permit output of HTTP GETs as program acquisition requests corresponding to all record schedulings performed by the clients to the network tuner 200. When HTTP GETs as plural program acquisition requests in overlapping time frames are received, the server-record-scheduling-information managing unit 202 of the network tuner 200 applies a selection algorithm defined by the server-record-scheduling-information managing unit 202 and determines contents to be actually recorded.

After this determination processing, the server-record-scheduling-information managing unit 202 transmits [status code OK], which is a status code indicating that record execution is possible and transmission of program information is possible, to the client that has transmitted HTTP GET corresponding to record execution contents. After receiving the status code from the network tuner 200, the client starts reception of broadcast contents and executes record processing. When it is difficult to respond to acquisition requests (HTTP GETs) for recorded programs from the clients because of overlapping record schedulings or the like, the server-record-scheduling-information managing unit 202 outputs, [HTTP 503 Service Unavailable], which is a status code indicating that it is difficult to perform information provision processing corresponding to the HTTP GETs, to the clients.

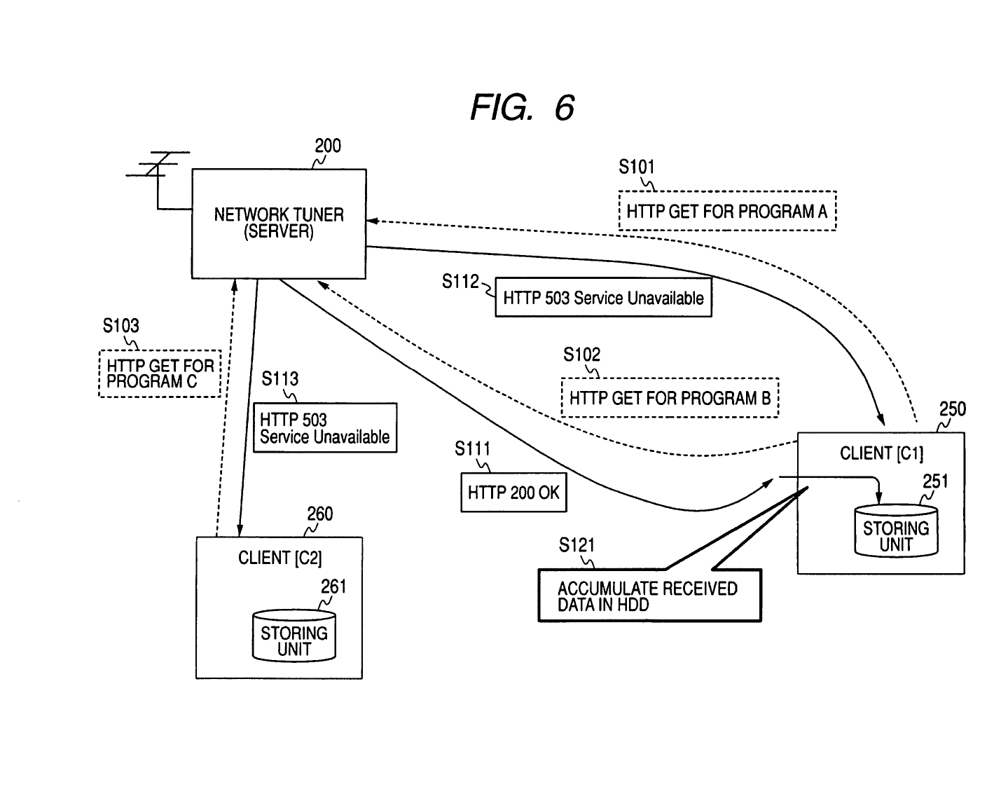

A sequence concerning the processing described above is explained with reference to FIG. 6. FIG. 6 shows a processing sequence of processing performed when the record scheduling list 302 shown in FIG. 4 is set. In other words, the processing sequence is a processing sequence of processing performed when record schedulings described below are set in a record scheduling list 302.

(1) Record Scheduling Data 311

Record scheduling for the program A (broadcast time: 2007 Jan. 14, 15:00 to 16:00) by the client [C1]

(2) Record Scheduling Data 312

Record scheduling for the program B (broadcast time: 2007 Jan. 14, 15:00 to 16:30) by the client [C1]

(3) Record Scheduling Data 313

Record scheduling for the program C (broadcast time: 2007 Jan. 14, 15:00 to 17:00) by a client [C2]

The client [C1] 250 and the client [C2] 260 respectively transmit browse requests for a record scheduling list (CDS Browse) to the network tuner 200 before 14:58, acquire the record scheduling list 302 shown in FIG. 4, and store the record scheduling list 302 in storing units of the clients as management data of the client-record-scheduling-information managing units 252 of the respective clients. Record processing units of the respective clients output, with reference to the record scheduling list, HTTP GETs to the network tuner 200 as transmission requests for recorded programs before (e.g., two minutes before) the start of record scheduling times of the clients.

Processing in steps S101 to S103 shown in FIG. 6 is executed all at once at 14:58 before (e.g., two minutes before) the start of the record scheduling times.

In steps S101 and S102, the client [C1] 250 transmits HTTP GETs in which URLs corresponding to the programs A and B are set to the network tuner 200.

In step S103, the client [C2] 260 transmits HTTP GET for setting a URL corresponding to the program C to the network tuner 200.

The network tuner 200 continues to maintain connection with the respective clients at the program start times with respect to the received HTTP GETs.

The network tuner 200 selects one record execution program from record schedulings from the clients in an identical time frame according to a judgment algorithm of the network tuner 200 at program start time (15:00) or before the time. The selection algorithm is an algorithm decided in advance in the network tuner 200. It is possible to apply algorithms of various forms, for example, an algorithm for giving priority to a record execution program with a small channel number. A specific example of the algorithm is explained later.

For example, it is assumed that the program B requested by the client [C1] is selected as a recording object by the selection algorithm. The network tuner 200 executes processing described below on the basis of a determination result of this record execution program.

In step S111, the network tuner 200 transmits a status code [status code], which indicates that program recording is executed, in response to HTTP GET for the program B received from the client [C1] 250 and starts transmission of broadcast data.

In steps S112 and S113, the network tuner 200 transmits a status code [status code of Service Unavailable], which indicates that execution of program recording is not started, in response to HTTP GET for the program A received from the client [C1] and HTTP GET for the program C received from the client [C2]. The status code [status code of Service Unavailable] means that “other record scheduling is given priority”.

The client [C1] 250 receives the status code [status code], which indicates that program recording is executed. Then the client [C1] 250 performs record processing for receiving the program B transmitted from the network tuner 200 and storing broadcast data received under the control by the record processing unit 254 in the storing unit 251 such as an HD.

The client [C1] 250 receives the status code [status code of Service Unavailable], which indicates that execution of program recording is not started, for the program A. The client [C2] 260 receives the status code [status code of Service Unavailable] for the program C. Then, the client [C1] 250 and the client [C2] 260 may transmit HTTP GETs corresponding to these programs even after 15:00. In such a case, the network tuner 200 already knows that recording of the program B is selected, the network tuner 200 repeatedly transmits the status code [status code of Service Unavailable], which indicates that execution of program recording has not been started, as a response to these HTTP GETs.

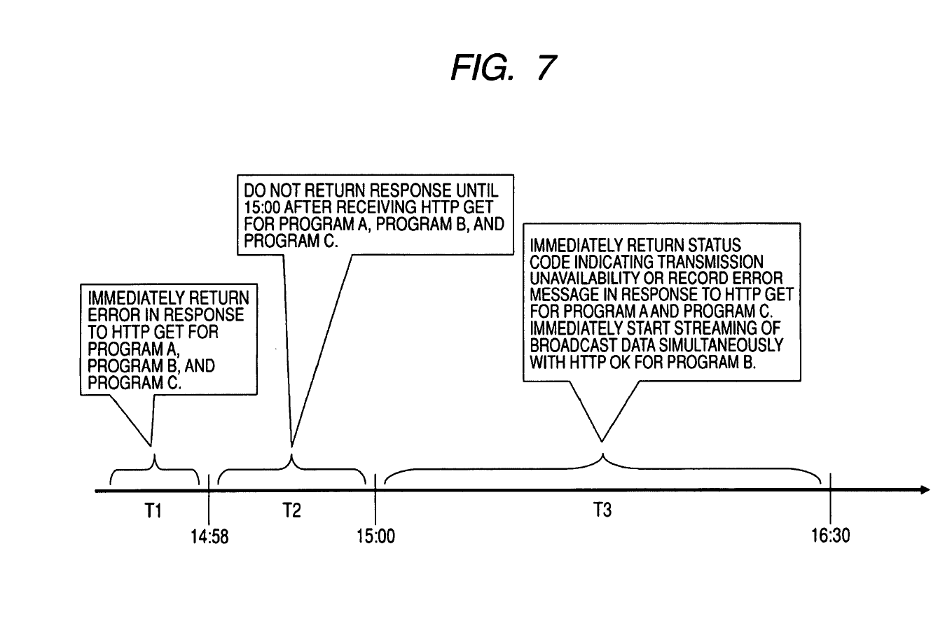

A time chart representing a relation between a change in a response of the network tuner 200 to HTTP GETs as content transmission requests received from the clients and time is shown in FIG. 7.

The response of the network tuner 200 is changed according to the following three time frames:

(a) time [T1] before reception start time (14:58) of a program transmission request;

(b) time [T2] from the reception start time (14:58) of the program transmission request to program start time (15:00); and

(c) time [T3] after the program start time (15:00).

First, in (a) the time [T1] before the reception start time (14:58) of the program transmission request, when HTTP GETs are received as content transmission requests for the programs A, B, and C from the clients, the network tuner 200 immediately returns an error.

In (b) the time [T2] from the reception start time (14:58) of the program transmission request to the program start time (15:00), when HTTP GETs are received as content transmission requests for the programs A, B, and C from the clients, the network tuner 200 confirms that time is within reception time, continues connection with the clients and stands by until the program start time (15:00). When the program start time (15:00) comes, the network tuner 200 executes the processing explained with reference to FIG. 6. The network tuner 200 transmits the status code [status code], which indicates that program recording is executed, in response to HTTP GET for a record execution program determined by execution of the selection algorithm in the network tuner 200 and starts transmission of broadcast data. The network tuner 200 transmits the status code [status code of Service Unavailable], which indicates that execution of program recording is not started, in response to HTTP GETs for the programs not selected.

In (c) the time [T3] after the program start time (15:00), the network tuner 200 transmits the status code [status code of Service Unavailable], which indicates that execution of program recording is not started, in response to HTTP GETs for the programs A and C. The network tuner 200 transmits the status code [status code], which indicates that program recording is executed, in response to HTTP GET for the record execution program and executes streaming transmission processing for the program.

When plural record schedulings are present in an identical time frame, the server-record-scheduling-information managing unit 202 of the network tuner 200 determines one record execution program in accordance with an algorithm set in advance. Various algorithms are applicable as this selection algorithm. An example of the algorithm is explained. For example, an algorithm formed by steps described below is applicable.

(Step S1)

Checking a broadcast program, checking whether a record-scheduled program is broadcasted, and setting a program, broadcast of which is canceled, as being excluded from recording objects. It is likely that a program is postponed or cancelled on account of a broadcasting station's schedule. Such record scheduling is set as being excluded from recording objects.

(Step S2)

Classifying effective record schedulings not excluded from recording objects in step S1 into the following two categories:

(Category 1) record scheduling set according to the user's intention; and

(Category 2) record scheduling automatically registered by an “automatic” function.

“Automatic” means a function of automatically record-scheduling, when the user registers conditions such as a keyword and a genre, a program that matches the conditions.

(Step s3)

As a result of the categorization in step S2,

(S3-a)

when the categories 1 and 2 are mixed, giving priority to record scheduling set according to the user's intention; and

(S3-b)

when plural record schedulings registered according to the user's intention are present, verifying whether a “degree of priority” of user setting is given and, when the degree of priority is given, selecting record scheduling with a high degree of priority. For example, the client can execute “protection processing” in which identification information is given to record scheduling with highest priority. Record scheduling set by “protection processing” is given highest priority. When record schedulings with an identical “degree of priority” are present, record scheduling set last is selected.

(S3-c)

As a Result of the Categorization in Step S2, when there are only record schedulings registered by the “automatic” function, selecting record scheduling set last out of the record schedulings registered by the “automatic” function.

The server-record-scheduling-information managing unit 202 of the network tuner 200 executes, for example, the selection algorithm described above and determines only one record scheduling to be set as a record execution object out of plural record schedulings in overlapping time. The selection algorithm is only an example. Algorithms other than the algorithm may be applied. For example, it is possible to use algorithms described below.
Holding a record scheduling history in the past, deducing the user's taste from the record scheduling history, and selecting record scheduling matching the user's taste most.
If a service that allows the user to learn how many people scheduling to record a program is present on the Internet, selecting record scheduling with a largest number of people.

For example, such algorithms may be executed.

Advantages realized by the processing according to this embodiment are, for example, as described below.

Since the network tuner unitarily manages a record scheduling list,

(A) Plural clients can share an only one record scheduling list. In other words, the respective clients can refer to the record scheduling list held by the network tuner. Inquiries and the like among the clients are unnecessary.

(B) Even if there are temporally overlapping record schedulings, one recording is executed according to the selection algorithm executed by the network tuner. When a determination algorithm for determining which record scheduling is given priority is changed in the server, the clients are not affected.

(C) It is possible to unitarily manage “protection processing” executed as processing corresponding to record scheduling to which the user desires to give priority.

In the processing according to this embodiment, the client only has to check, on the basis of a record scheduling list, information concerning record scheduling executed by the client and output a reception request (HTTP GET) to the network tuner according to recording start time. Therefore, complicated judgment processing in the client is unnecessary and a processing load is reduced.

Therefore, there are advantages described below.

(A) Regardless of whether record schedulings overlap or do not overlap, the client only has to make connection to the server in the same manner.

(B) The client does not have to care about presence or absence of other clients.

(C) Even when other clients are not present and there are overlapping record schedulings for the client itself, the client only has to perform recording in the same manner without caring about the overlapping record schedulings.

(D) The client can create record scheduling without caring about overlapping.

[3. Control of Record Execution Start Time in the Client Based on the Record Scheduling List]

Control of record execution start time in the client based on the record scheduling list is explained.

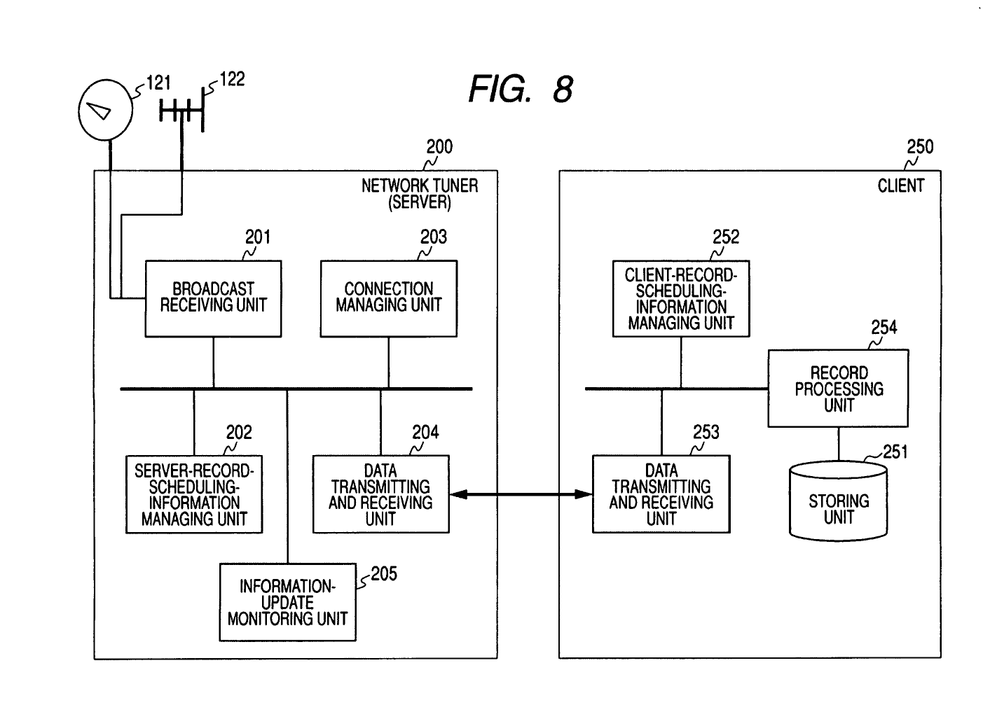

The structure of the network tuner 200 and the client 250 according to a second embodiment of the present invention is shown in FIG. 8.

The network tuner 200 includes, as shown in FIG. 8, the broadcast receiving unit 201, the server-record-scheduling-information managing unit 202, the connection managing unit 203, the data transmitting and receiving unit 204, and an information-update monitoring unit 205. The broadcast receiving unit 201 receives broadcast data through the antennas 121 and 122, extracts broadcast contents (MPEG data) corresponding to a tuned-in channel, and outputs the broadcast contents to the data transmitting and receiving unit 204. The data transmitting and receiving unit 204 outputs the received data to the client 250. The outputted data is, for example, a record-scheduled program. Program provision processing is executed on the basis of reception of HTTP GET in which a URL corresponding to the program outputted from the client 250 is set.

The server-record-scheduling-information managing unit 202 collectively manages record scheduling information from respective clients connected to a network, for example, in the example shown in FIG. 1, the clients 250 and 260. Specifically, the server-record-scheduling-information managing unit 202 creates a record scheduling list based on the record scheduling information from the respective clients and provides the client 250 with the created record scheduling list on the basis of a request (a CDS Browse request) from the client 250. The connection managing unit 203 executes management of communication connection with the client 250 and the other clients.

The information-update monitoring unit 205 monitors whether it is necessary to update information managed by the server-record-scheduling-information managing unit 202, i.e., information corresponding to a record scheduling list. For example, the information-update monitoring unit 205 detects information such as a change in broadcast time of a record-scheduled program according to a message or the like from a broadcasting station from which the program is received from the broadcast receiving unit 201. When it is necessary to update the information managed by the server-record-scheduling-information managing unit 202, the information-update monitoring unit 205 requests the server-record-scheduling-information managing unit 202 to perform update processing.

When the server-record-scheduling-information managing unit 202 executes update of information managed by the CDS, the server-record-scheduling-information managing unit 202 transmits an update notice (GENA Notify) to the clients as described above.

The structure of the client 250 shown in FIG. 8 is the same as that explained with reference to FIG. 2. The client 250 includes the storing unit 251 that records, for example, a recorded program, the client-record-scheduling-information managing unit 252 that manages record scheduling information in the client, the data transmitting and receiving unit 253 that executes data communication with the network tuner (the server) 200, and the record processing unit 254 that executes record processing.

Besides the management of the record scheduling information in the client and the processing for outputting the record scheduling information to the network tuner 200, the client-record-scheduling-information managing unit 252 executes processing for transmitting the browse request (CDS Browse) to the network tuner 200 and acquiring a record scheduling list created by the network tuner 200. The record processing unit 254 judges, on the basis of information acquired from the client-record-scheduling-information managing unit 252, specifically, the record scheduling information in the client and information concerning the record scheduling list acquired from the network tuner 200, time when record processing can be started. The record processing unit 254 transmits HTTP GET in which a URL corresponding to a record-scheduled program is set to the network tuner 200 through the data transmitting and receiving unit 253.

The server-record-scheduling-information managing unit 202 of the network tuner 200 shown in FIG. 8 is inputted with record scheduling information from the clients, creates a record scheduling list, manages the record scheduling list by applying the CDS, and provides the clients with the record scheduling list on the basis of a browse request (CDS Browse) from the client. When the record scheduling list as data managed by the CDS is updated, the server-record-scheduling-information managing unit 202 executes transmission of GENA Notify as notification processing for notifying the clients of information change and update. For example, when one of the clients performs program record scheduling and the record scheduling list managed by the server-record-scheduling-information managing unit 202 is changed, the respective clients can learn the change from the notification processing (GENA Notify).

In the client 250 shown in FIG. 8, the client-record-scheduling-information managing unit 252 outputs a browse request (CDS Browse) to the network tuner 200, stores a record scheduling list in a storing unit accessible by the client-record-scheduling-information managing unit 252, and manages the record scheduling list. The record processing unit 254 issues, on the basis of the record scheduling list, a content transmission request as a record execution processing request, i.e., HTTP GET in which a URL corresponding to a program is set to the network tuner 200 and starts record processing.

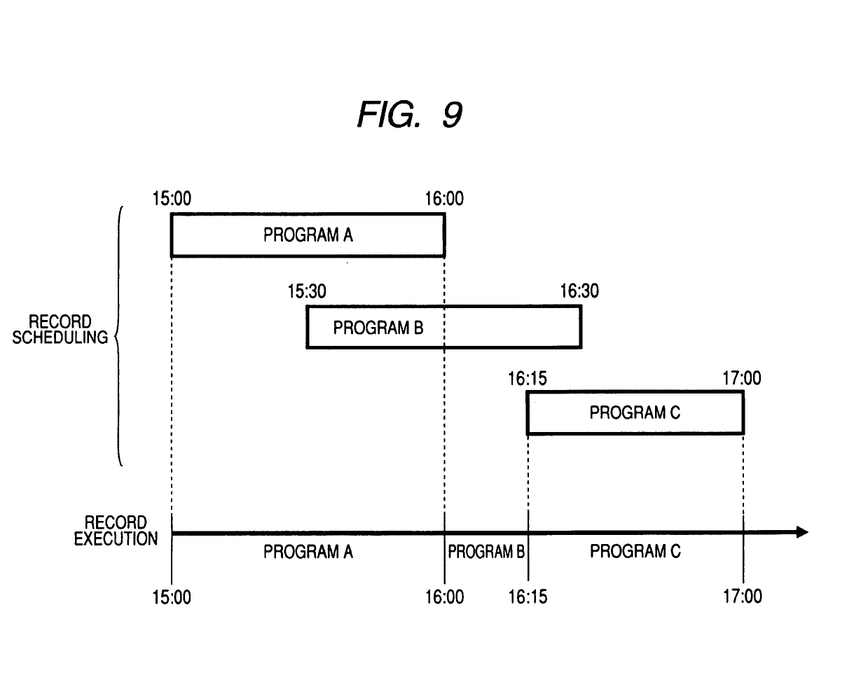

In such processing, it is assumed that certain one client, e.g., the client 250 shown in FIG. 1 executes plural record schedulings and record scheduling times of the record schedulings partially overlap. For example, as shown in FIG. 9, record schedulings of three programs described below are considered.

Program A (broadcast time: 15:00 to 16:00)

Program B (broadcast time: 15:30 to 16:30)

Program C (broadcast time: 16:15 to 17:00)

The network tuner 200 selects record scheduling for actually executing recording out of these plural record schedulings. In other words, the network tuner 200 determines a record execution program according to a selection algorithm executed in the network tuner 200.

For example, according to the selection algorithm, first, after recording of the program A is finished, recording of the program B is started. Then, when start time of the program C comes, the recording of the program B is finished.

It is assumed that this processing is determined.

In other words, it is assumed that record processing in the following sequence is determined:

executing the recording of the program A from 15:00 to 16:00;

executing the recording of the program B from 16:00 to 16:15, and

executing the recording of the program C from 16:15 to 17:00.

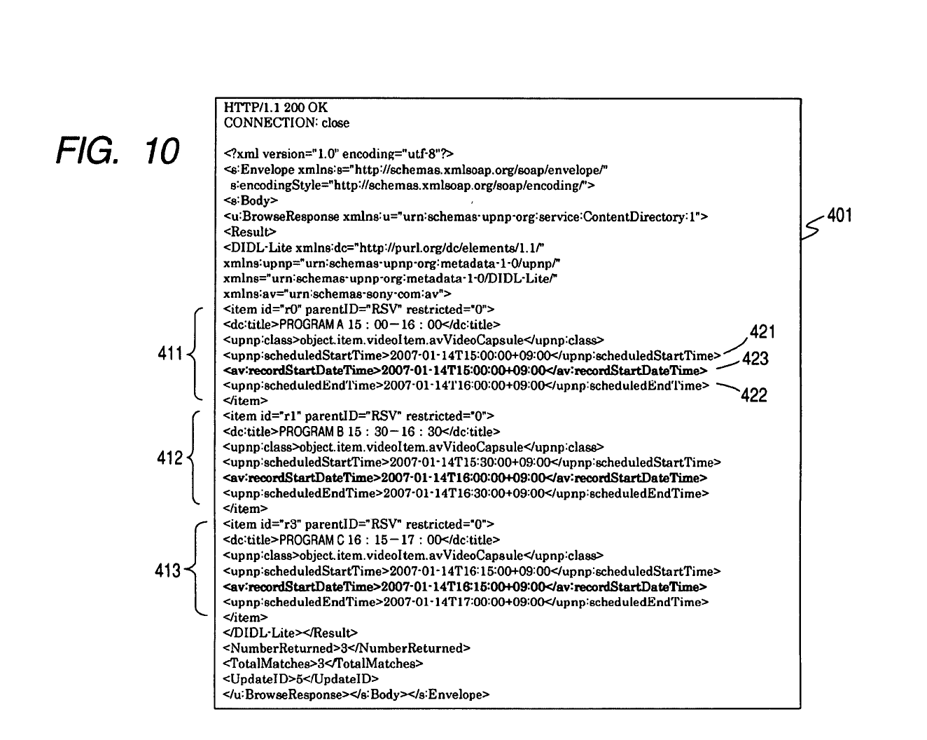

When a record scheduling list browse request (CDS Browse) from the client 250 that has performed record scheduling, i.e., the record scheduling list browse request (CDS Browse) 301 explained with reference to FIG. 3 is received, the network tuner 200 provides the client 250 with a record scheduling list 401 shown in FIG. 10. In this example of processing, only record scheduling from the one client 250 is present. The client identification information included in the record scheduling list explained with reference to FIG. 4 is omitted.

In the record scheduling list 401 shown in FIG. 10, record scheduling information from the client 250 is recorded. Data 411, 412, and 413 are record scheduling corresponding data corresponding to individual kinds of record scheduling information, respectively, as described below.

(1) Record scheduling corresponding data 411: Program A (broadcast time: 15:00 to 16:00)

(2) Record scheduling corresponding data 412: Program B (broadcast time: 15:30 to 16:30)

(3) Record scheduling corresponding data 413: Program C (broadcast time: 16:15 to 17:00)

In each of the record scheduling corresponding data 411, 412, and 413 included in the record scheduling list described in this example, as information concerning record scheduling executed by the client, record scheduling information described below is recorded.

Program start time information 421 of a record-scheduled program: <upnp:scheduledStartTime>

Program end time information 422 of the record-scheduled program: <upnp:scheduledEndTime>

Besides, information determined as a result of a recorded program selection algorithm executed by the network tuner 200, i.e., record execution start time information 423: <av:recordStartDateTime> is recorded.

The client 250 can determine, on the basis of the record execution start time information 423 described in the record scheduling list 401 shown in FIG. 10, output timing of content acquisition requests [HTTP GET] corresponding to respective programs. The record processing unit 254 of the client 250 checks, with reference to the record scheduling list 401 shown in FIG. 10 acquired from the network tuner 200 by the client-record-scheduling-information managing unit 252, record execution start time information in the respective kinds of record scheduling information recorded in the record scheduling list 401. The record processing unit 254 transmits program content acquisition requests [HTTP GET] corresponding to respective record-scheduled programs to the network tuner 200 in accordance with the record execution start time information.

The network tuner 200 receives the program content acquisition request [HTTP GET] from the client 250 from two minutes before recording start time. The record processing unit 254 of the client 250 transmits HTTP GET for the program A after 14:58, transmits HTTP GET for the program B after 15:58, and transmits HTTP GET for the program C after 16:13 in accordance with the record execution start time information in the respective kinds of record scheduling information recorded in the record scheduling list 401 shown in FIG. 10. In this way, the record processing unit 254 can transmit program acquisition requests at times corresponding to recording start times of the respective programs determined by the network tuner 200.

As described above, in this embodiment, the network tuner 200 executes processing for recording actual recording start times of respective record-scheduled programs determined by executing selection of recorded programs on the basis of record scheduling from the client and provides the client with a record scheduling list in which record execution start time information is recorded. Therefore, the client can learn actual recording start time and output a content acquisition request [HTTP GET] to the network tuner 200 at timing corresponding to the recording start time.

Consequently, even when recording from record scheduling time is not started, the client can transmits the content acquisition request [HTTP GET] at timing adjusted to the actual recording start time without executing processing for repeatedly outputting HTTP GET from program start time in record scheduling until the actual recording start time. Therefore, processing loads in both the apparatuses can be reduced and useless communication in the network can be reduced.

Broadcast time of a program may be changed on account of a broadcasting station's schedule. The network tuner 200 receives information concerning such a change in broadcast time from the broadcast station. When broadcast time is changed, the network tuner 200 checks, with reference to a record scheduling list, whether broadcast time of a program corresponding to a record-scheduled program is changed. When the broadcast time of the program is changed, the network tuner 200 executes processing for updating the record scheduling list.

As described above, the server-record-scheduling-information managing unit 202 of the network tuner 200 shown in FIG. 8 is inputted with record scheduling information from the client, creates a record scheduling list, and manages the record scheduling list by applying the CDS. When the information-update monitoring unit 205 detects that it is necessary to update the record scheduling list, detection information is inputted to the server-record-scheduling-information managing unit 202. The server-record-scheduling-information managing unit 202 executes update of the record scheduling list.

When the update of the record scheduling list is completed, the server-record-scheduling-information managing unit 202 executes transmission of GENA Notify as processing for notifying the client that information change and update are performed. Therefore, when the record scheduling list is changed, the client can learn the change according to the notification processing (GENA Notify). After the notice of change, the client can receive the updated record scheduling list by executing CDS Browse as a record scheduling list browse request.

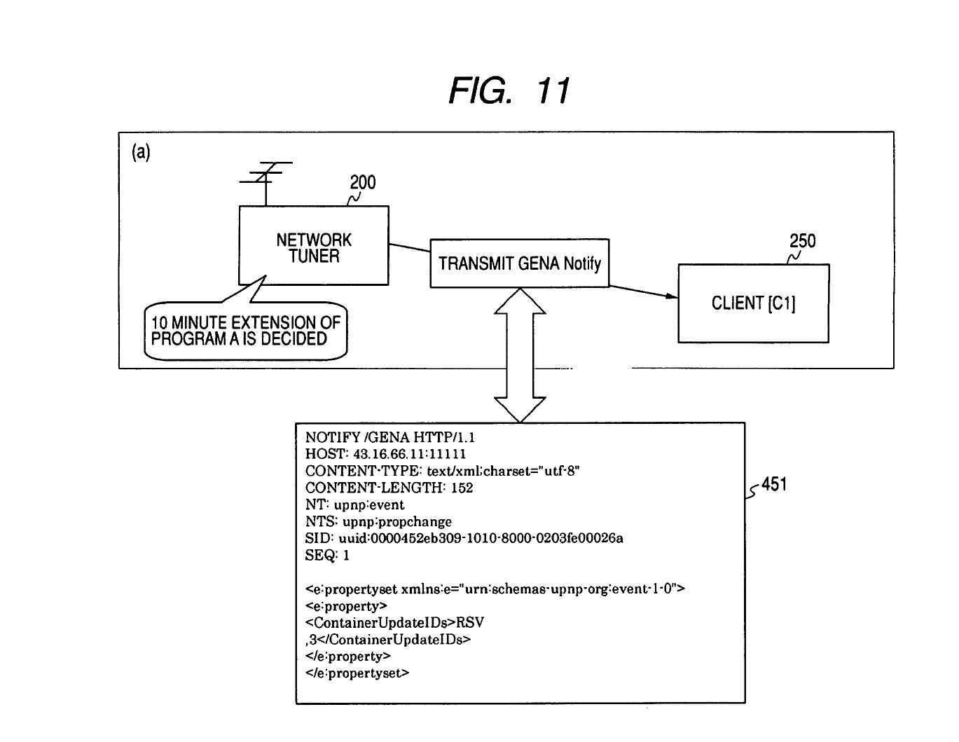

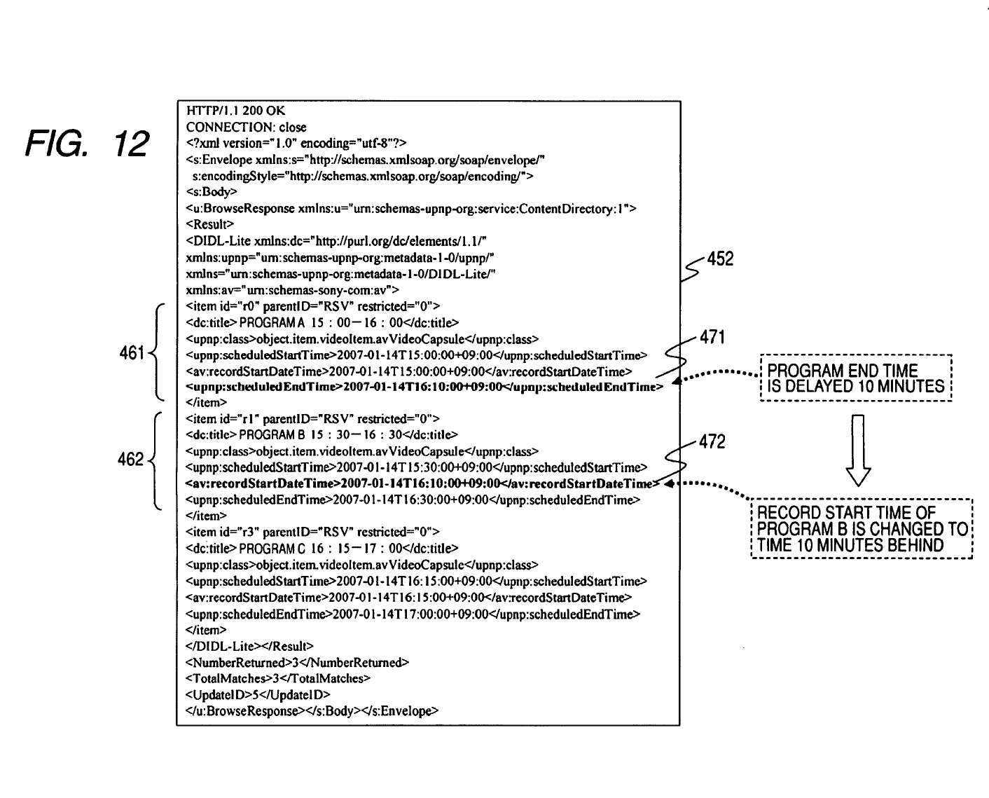

For example, an example of processing performed when end time of the program A is delayed by ten minutes on account of the broadcasting station's schedule is explained with reference to FIGS. 11 and 12. As shown in (a) in FIG. 11, the server-record-scheduling-information managing unit 202 of the network tuner 200 updates a record scheduling list managed in the CDS. After execution of this update processing, the server-record-scheduling-information managing unit 202 executes transmission of GENA Notify as processing for notifying the client 250 that information update is performed.

Update notice [GENA Notify] data 451 shown in FIG. 11 is transmitted from the network tuner 200 to the client 250. Management information in the CDS is managed in units of containers as sets of data items corresponding to various categories. When information belonging to a certain container is updated, an update notice [GENA Notify] is transmitted in units of the container. In this example, since record scheduling list information is set as one item of an RSV container, GENA Notify for the RSV container is transmitted to the client 250.

When the update notice (GENA Notify) is received, the client-record-scheduling-information managing unit 252 of the client 250 executes a record scheduling list browse request (CDS Browse) as processing for acquiring the updated record scheduling list. The network tuner 200 transmits the updated record scheduling list to the client 250 in response to the record scheduling list browse request (CDS Browse) from the client 250.

An example of data of the updated record scheduling list is shown in FIG. 12. A record scheduling list 452 shown in FIG. 12 is a list obtained by updating the initial record scheduling list 401 explained with reference to FIG. 10.

As program end time information 471 of a record-scheduled program: <upnp:scheduledEndTime> in record scheduling information 461 corresponding to the program A, data set as [16:00] in the initial record scheduling list 401 shown in FIG. 10 is changed to [16:10] in the updated record scheduling list 452 shown in FIG. 12.

According to the extension of the program A, as record execution start time information 472: <av:recordStartDateTime> in record scheduling information 462 corresponding to the program B, data set as [16:00] in the initial record scheduling list 401 shown in FIG. 10 is changed to [16:10] in the updated record scheduling list 452 shown in FIG. 12.

The client-record-scheduling-information managing unit 252 of the client 250 stores the updated record scheduling list 452 in the storing unit of the client 250. The record processing unit 254 of the client 250, which performs a content acquisition request in record processing, transmits a content acquisition request for the program B, i.e., HTTP GET for the program B to the network tuner 200 at [16:08] two minutes before [16:10] with reference to the updated record scheduling list 452.

As described above, even when broadcast time of a record-scheduled program is changed, the client can receive an update notice (GENA Notify) from the network tuner, acquire a record scheduling list updated by executing a record scheduling list browse request (CDS Browse), determine transmission timing of a content acquisition request (HTTP GET) on the basis of the updated record scheduling list, and transmit the content acquisition request. Therefore, it is possible to perform processing for transmitting the content acquisition request at timing adjusted to actual recording start time.

In the embodiment described above, the network tuner presents a record scheduling list in which actual recording start times corresponding to respective programs are recorded to the client. However, the network tuner may create a record scheduling list in which recording end times are recorded instead of the recording start times and provide the client with the record scheduling list. Since the client finds recording end time of record scheduling of recording currently being performed in overlapping record schedulings, the client can judge start time of the other overlapping record scheduling.

Alternatively, the network tuner may record, instead of the recording start time, priority order information for each entry of respective record schedulings, which are recorded in the record scheduling list, in the record scheduling list and provide the client with the record scheduling list. The client can judge, on the basis of priority orders and start time information <upnp:scheduledStartTime> of record-scheduled programs in the respective record scheduling entries, which program is actually recorded. When there are plural record schedulings overlapping in time, it is possible to judge that record scheduling with a high priority order is preferentially recorded.

In the network tuner, it is possible to execute recording of actual recording start time information <av:recordStartDateTime> corresponding to respective record-scheduled programs in the record scheduling list at various timings. For example, it is possible to execute the recording when record scheduling is inputted from the client, when a selection algorithm for a record execution program is executed and a recorded program is determined in the network tuner, or when recording time of any one of record schedulings overlapping in time comes.

The client that executes record scheduling may be able to set priority orders of record scheduling entries overlapping in recording time. For example, the client transmits a setting request for the record scheduling entry to the network tuner using a new object creation request for the CDS (CDS createObject) as management for the record scheduling list in the network tuner or CDS updateObject as an information update request. In this case, the client sets a priority order to a request to be transmitted (a SOAP request) and transmits the request. The network tuner records the priority order in the record scheduling list.

According to this embodiment, since the network tuner can unitarily manage the record scheduling list, there are advantages described below.

(A) When the client manages the record scheduling list, synchronization processing that needs to be performed when plural clients are present is unnecessary.

(B) In the case of overlapping record schedulings, the client does not need to know an algorithm for judging to which of the record schedulings the network tuner gives priority.

(C) Even if an algorithm for preferentially recording any one of overlapping record schedulings is changed in the server, the client is not affected.

Moreover, since the network tuner notifies the client of recording start times during overlapping record schedulings, the client does not need to perform unnecessary processing such as polling like repeated transmission of a content acquisition request (HTTP GET) by the time when recording in overlapping record schedulings is actually started. Therefore, loads on the network tuner and the client are reduced and useless data communication on the network is controlled.

[4. Time Information Management in Record Processing]

A third embodiment of the present invention is explained below. In the third embodiment, time management for recording start time and recording end time in record processing by the client is accurately performed.

For example, in the configuration shown in FIG. 1, the clients 250 and 260 perform record processing for receiving broadcast contents received by the network tuner 200 and storing the broadcast contents in the storing units 251 and 261 of the clients. In this case, the clients 250 and 260 perform the record processing with reference to time information recorded in the record scheduling list including recording start time and recording end time. In performing the record processing, the clients 250 and 260 confirm that time recorded in the record scheduling list comes and perform recording start processing and recording end processing using clocks provided in the clients.

When the clients 250 and 260 receive information concerning a record scheduling list held by the network tuner 200 and perform the processing using the clocks of the clients, if the clocks of the clients are not correct, it is difficult to perform recording start from accurate program start time and end processing. For example, when the clocks of the clients 250 and 260 that perform recording are five minutes behind, recording for first five minutes is not performed and an unnecessary program is recorded in last five minutes.

In the embodiment explained below, such a situation is prevented. Specifically, the network tuner 200 acquires present time information included in data received through the broadcast receiving unit and provides the clients 250 and 260 with the present time information together with the record scheduling list. The clients 250 and 260 compare the present time information recorded in the record scheduling list and time information of the clocks of the clients. The clients 250 and 260 calculate a difference between the present time and correct time of the clocks of the clients, hold information concerning the difference, and execute recording start and end processing taking into account the difference information.

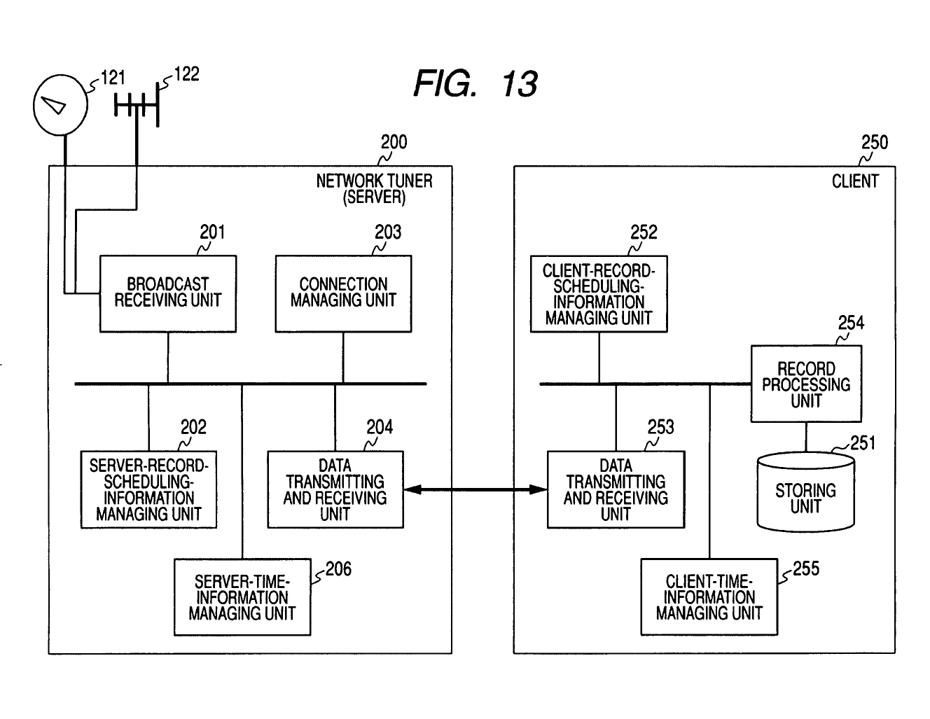

The structure of the network tuner 200 and the client 250 according to this embodiment is shown in FIG. 13. The network tuner 200 includes, as shown in FIG. 13, the broadcast receiving unit 201, the server-record-scheduling-information managing unit 202, the connection managing unit 203, the data transmitting and receiving unit 204, and a server-time-information managing unit 206. The broadcast receiving unit 201 receives broadcast data through the antennas 121 and 122, extracts broadcast contents (MPEG data) corresponding to a tuned-in channel, and outputs the broadcast contents to the data transmitting and receiving unit 204. The data transmitting and receiving unit 204 outputs the received data to the client 250. The outputted data is, for example, a record-scheduled program. Program provision processing is executed on the basis of reception of HTTP GET in which a URL corresponding to the program outputted from the client 250 is set.

The server-record-scheduling-information managing unit 202 collectively manages record scheduling information from respective clients connected to a network, for example, in the example shown in FIG. 1, the clients 250 and 260. Specifically, the server-record-scheduling-information managing unit 202 creates a record scheduling list based on the record scheduling information from the respective clients and provides the client 250 with the created record scheduling list on the basis of a request (a CDS Browse request) from the client 250. The connection managing unit 203 executes management of communication connection with the client 250 and the other clients.

The broadcast receiving unit 201 receives present time information included in a broadcast wave and outputs the present time information to the server-time-information managing unit 206. The server-time-information managing unit 206 stores and manages the present time information received by the broadcast receiving unit 201. The present time information managed by the server-time-information managing unit 206 is recorded in the record scheduling list managed by the server-record-scheduling-information managing unit 202 and provided to the client 250 through the data transmitting and receiving unit 204.

The client 250 shown in FIG. 13 includes, as explained with reference to FIG. 2, the storing unit 251 that records, for example, a recorded program, the client-record-scheduling-information managing unit 252 that manages record scheduling information in the client, the data transmitting and receiving unit 253 that executes data communication with the network tuner (the server) 200, and the record processing unit 254 that executes record processing and further includes a client-time-information managing unit 255.

Besides the management of the record scheduling information in the client 250 and the processing for outputting the record scheduling information to the network tuner 200, the client-record-scheduling-information managing unit 252 executes processing for transmitting the browse request (CDS Browse) to the network tuner 200 and acquiring a record scheduling list created by the network tuner 200. The record processing unit 254 judges, on the basis of information acquired from the client-record-scheduling-information managing unit 252, specifically, the record scheduling information in the client 250 and information concerning the record scheduling list acquired from the network tuner 200, time when record processing can be started. The record processing unit 254 transmits HTTP GET in which a URL corresponding to a record-scheduled program is set to the network tuner 200 through the data transmitting and receiving unit 253.

The client-time-information managing unit 255 reads the present time information recorded in the record scheduling list provided from the network tuner 200, calculates a difference between the present time and time of a not-shown clock of the client 250, and determines execution timing for recording start and recording end processing.

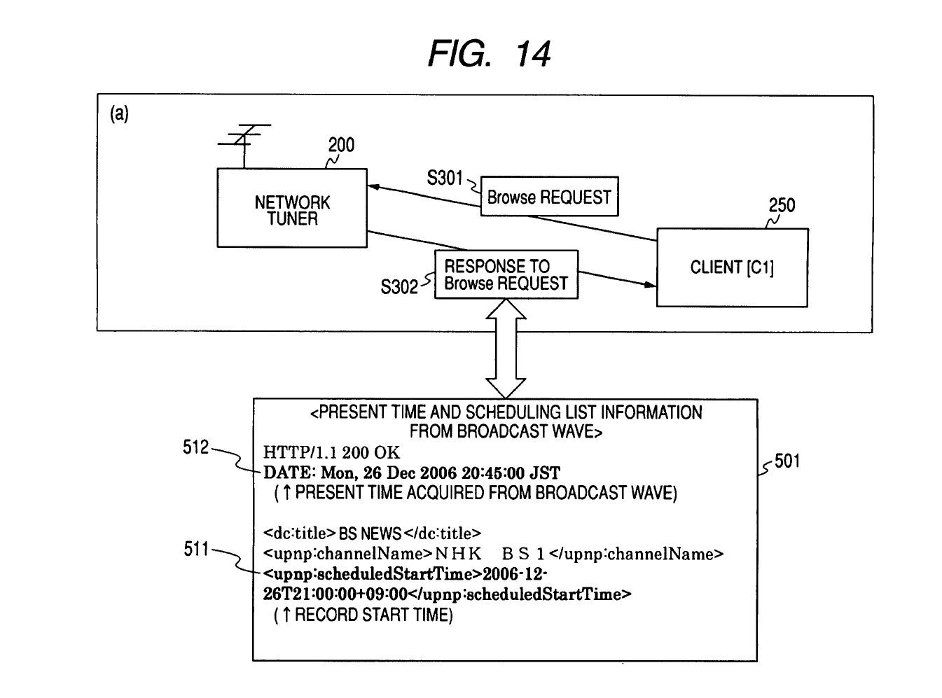

A processing sequence in which the client 250 that executes recording receives the record scheduling list from the network tuner 200 and an example of the data structure of the record scheduling list are explained with reference to FIG. 14.

(a) in FIG. 14 shows a communication processing sequence between the client 250 and the network tuner 200 for executing processing for browsing a record scheduling list. First, in step S301, the client 250 transmits a CDS Browse request to the network tuner 200. The network tuner 200 receives the CDS Browse request and presents a record scheduling list as a response to the CDS Browse request.

The CDS Browse request outputted to the network tuner 200 by the client 250 in step S301 is CDS Browse request data 301, which is a record scheduling list browse request same as the data 301 explained with reference to FIG. 3.

In this embodiment, the server-record-scheduling-information managing unit 202 of the network tuner 200, which receives the record scheduling list browse request (the CDS Browse request), outputs a record scheduling list 501 shown in FIG. 14 to the client 250 as a response to the browse request.

The record scheduling list 501 shown in FIG. 14 is a record scheduling list created by the server-record-scheduling-information managing unit 202 of the network tuner 200 on the basis of record scheduling information from the respective clients. The record scheduling list 501 shown in FIG. 14 is shown as simplified data in which only items related to this embodiment are described.

In the record scheduling list 501, record scheduling information from a network-connected client is recorded. Specifically, start time information 511 of a recorded program is recorded. Moreover, present time information 512 is also recorded in the record scheduling list 501.

The present time information 512 is equivalent to present time information included in a broadcast wave received through the broadcast receiving unit 201 at timing when the server-record-scheduling-information managing unit 202 transmits the record scheduling list 501 to the client. Present time information received through the broadcast receiving unit 201 is provided to the server-record-scheduling-information managing unit 202 through the server-time-information managing unit 206 and recorded in the record scheduling list 501 in the server-record-scheduling-information managing unit 202. In this embodiment, the record scheduling list 501 in which accurate present time information included in the broadcast wave is additionally described in this way is provided to the client 250.

When the client-record-scheduling-information managing unit 252 of the client 250 receives the record scheduling list 501, the client-time-information managing unit 255 reads the present time information recorded in the record scheduling list, calculates a difference between the present time and time of the clock of the client 250, and determines execution timing of recording start and recording end processing, i.e., record processing execution timing. The record processing execution timing information is provided to the record processing unit 254. The record processing unit 254 determines recording start timing and recording end timing on the basis of the record starting time recorded in the record scheduling list and information concerning the time difference between the time of the client clock and the accurate time provided from the client-time-information managing unit 255 and executes the processing. For example, the record processing unit 254 determines transmission timing of HTTP GET as a recorded content acquisition request and executes the processing.

In the example explained in the embodiment described above, processing timing in the record processing of the client is determined. However, it is possible to apply accurate time information provided from the network tuner not only to the record processing but also to processing for determining view timing. For example, when viewing is carried out using a timer on the basis of program information (EPG), accurate time is calculated from an error of the clock of the client in the same flow as described above. The client can determine acquisition timing of broadcast contents using a value of the time and start processing, i.e., content acquisition and reproduction.

According to this embodiment, since the network tuner (the server) and the client do not need to synchronize clocks, there are following effects.

(A) It is unnecessary to establish a special daemon for clock synchronization in the network tuner (the server).

(B) It is unnecessary to provide a special application for clock synchronization in the client.

(C) A risk adversely affecting processing running on the client is eliminated by changing the clock of the client.

The network tuner (the server) can simultaneously output present time and information based on time. Therefore, there are effects described below.

(A) Unnecessary information does not flow to the network and bands can be effectively used.

(B) Since a difference between the times can be calculated instantaneously, the client can easily perform processing.

Since this example of processing can be realized in a framework of an existing protocol, there is also an advantage that implementation of the processing is easy.

[5. Control of a Timestamp]

A fourth embodiment of the present invention is explained below. In this embodiment, control of a timestamp set in contents transmitted from the network tuner 200 to the client 250 is performed.

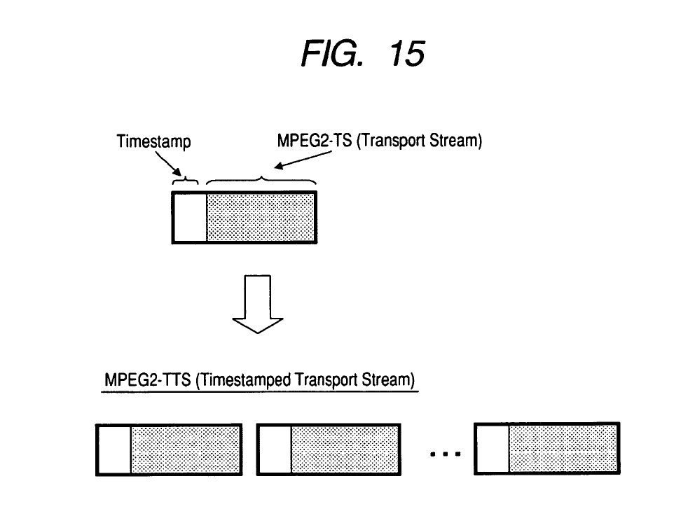

For example, the network tuner 200 shown in FIG. 1 transmits broadcast contents to the clients 250 and 260 that perform recording and viewing of the broadcast contents. Broadcast data received by the network tuner 200 through the antennas 121 and 122 is transmitted in an MPEG2-TS (Transport Stream) format. However, when the network tuner 200 receives the broadcast data and delivers the broadcast data to the network 150 in streaming, the network tuner 200 converts the MPEG2-TS format into an MEPG2-TTS (Timestamped TS) format. As shown in FIG. 15, MPEG2-TTS is a data stream format formed by data obtained by adding a timestamp to MPEG2-TS.

In other words, in delivering broadcast data on the network in response to requests of the clients 250 and 260, when necessary, the network tuner 200 adds a timestamp as time information conforming to reproduction order to data received from a broadcast and outputs the data. It is possible to arrange MPEG-2 data stored in a TS packet in the production order and reproduce the MPEG-2 data.

Digital broadcast data provided to the clients through networks is encrypted by the network tuner for prevention of illegal copying and outputted to the networks. For example, when digitized AV contents are circulated in a home through an IP home network, circulation conforming to the DTCP-IP (DTCP over IP) standard is performed. A server (a DTCP Source) as a content provision source and a client (a DTCP Sink) as a content provision destination share a key through an authentication procedure according to transmission and reception of an AKE command, encrypt the contents using the key, and transmit the contents.

On the premise described above, for example, the client 250 shown in FIG. 1 receives contents from the network tuner 200 and executes record processing. When a communication failure occurs and disables the client 250 to receive the contents, problems described below occur.

When the communication failure is restored and the client 250 resumes the recording, the network tuner 200 as the server has no means for knowing a value of a last timestamp of data successfully received and stored by the client 250. Therefore, a value of a timestamp given to a transmission packet (TTS) after the communication failure is restored and the data transmission is resumed and a value of a timestamp given to a transmitted packet (TTS) before the occurrence of the communication failure are discontinuous.

The data having discontinuous timestamps is received by the client 250 and stored in the storing unit 251. The client 250 acquires recorded contents from the storing unit 251 and reproduces the recorded contents in accordance with the timestamp. It is likely that a problem occurs in the reproduction.

When the data received by the client 250 and stored in the storing unit 251 is further transmitted to another client, for example, the client 260 shown in FIG. 1, the data (TTS) set with such discontinuous timestamps causes a problem. Such a problem occurs when the client 250 acts as a content provision server and delivers contents in streaming. This is because it is necessary to guarantee continuity of timestamps when the client 250 acts as a server and delivers the contents in streaming.

Therefore, when the client 250 acts as a content provision server and delivers the data having such discontinuous timestamps to another client 260 and the like in streaming, a code of recoded contents encrypted and stored in the storing unit 251 has to be once decoded and the timestamps have to be rewritten. Thereafter, processing for encrypting the recorded contents again and transmitting the recorded contents to the network is necessary. This is processing with an extremely heavy load.

In this embodiment, to make it unnecessary to perform such processing, the client notifies the network tuner (the server) of a value of a timestamp that should be set. For example, after suspension of data transmission due to a communication failure, the client checks a value of a timestamp set in a TTS packet, which is received data, and notifies the network tuner (the server) of a value of a timestamp having continuity with this value. The network tuner (the server) determines a value of a timestamp given to transmission data after recovery from the communication failure using the notified value and resumes the transmission.

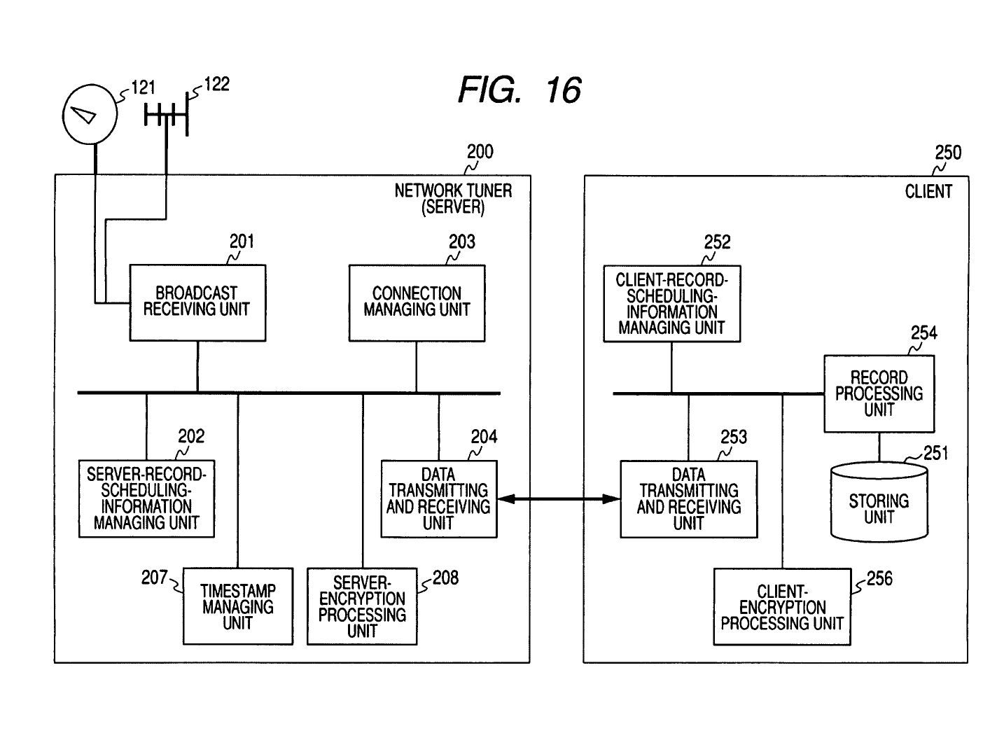

The structure of the network tuner 200 and the client 250 according to this embodiment is shown in FIG. 16. The network tuner 200 includes, as shown in FIG. 16, the broadcast receiving unit 201, the server-record-scheduling-information managing unit 202, the connection managing unit 203, the data transmitting and receiving unit 204, a timestamp managing unit 207, and a server-encryption processing unit 208. The broadcast receiving unit 201 receives broadcast data through the antennas 121 and 122, extracts broadcast contents (MPEG data) corresponding to a tuned-in channel, and outputs the broadcast contents to the data transmitting and receiving unit 204. The data transmitting and receiving unit 204 outputs the received data to the client 250. The outputted data is, for example, a record-scheduled program. Program provision processing is executed on the basis of reception of HTTP GET in which a URL corresponding to the program outputted from the client 250 is set.

The server-record-scheduling-information managing unit 202 collectively manages record scheduling information from respective clients connected to a network, for example, in the example shown in FIG. 1, the clients 250 and 260. Specifically, the server-record-scheduling-information managing unit 202 creates a record scheduling list based on the record scheduling information from the respective clients and provides the client 250 with the created record scheduling list on the basis of a request (a CDS Browse request) from the client 250. The connection managing unit 203 executes management of communication connection with the client 250 and the other clients.

The timestamp managing unit 207 determines a value of a timestamp set in MPEG2-TTS (Timestamped TS), which is a packet outputted through the network. For example, after communication with a client to which contents are transmitted is suspended, the timestamp managing unit 207 receives timestamp setting value information from the client through the data transmitting and receiving unit 204 and adds a timestamp starting from the value to MPEG2-TS data received from the broadcast receiving unit 201. MPEG2-TTS data created in this way is passed to the server-encryption processing unit 208.

The server-encryption processing unit 208 receives the MPEG-TTS data set with the timestamp by the timestamp managing unit 207, executes encryption processing on the MPEG-TTS data, and outputs the encrypted data to the data transmitting and receiving unit 204. The data transmitting and receiving unit 204 outputs the data encrypted by the server-encryption processing unit 208 to the client 250.

The client 250 shown in FIG. 16 includes, as explained with reference to FIG. 2, the storing unit 251 that records, for example, a recorded program, the client-record-scheduling-information managing unit 252 that manages record scheduling information in the client, the data transmitting and receiving unit 253 that executes data communication with the network tuner (the server) 200, and the record processing unit 254 that executes record processing and further includes a client-encryption processing unit 256.

Besides the management of the record scheduling information in the client and the processing for outputting the record scheduling information to the network tuner 200, the client-record-scheduling-information managing unit 252 executes processing for transmitting the browse request (CDS Browse) to the network tuner 200 and acquiring a record scheduling list created by the network tuner 200. The record processing unit 254 judges, on the basis of information acquired from the client-record-scheduling-information managing unit 252, specifically, the record scheduling information in the client and information concerning the record scheduling list acquired from the network tuner 200, time when record processing can be started. The record processing unit 254 transmits HTTP GET in which a URL corresponding to a record-scheduled program is set to the network tuner 200 through the data transmitting and receiving unit 253.

The client-encryption processing unit 256 executes decoding processing for encrypted data provided from the network tuner 200. In other words, the client-encryption processing unit 256 converts encrypted data received from the record processing unit 254 into encrypted data of a form suitable for storage and stores the encrypted data in the storing unit 251 such as an HDD. In this storage processing, the client-encryption processing unit 256 monitors a value of a timestamp of MPEG2-TTS of the stored data and passes timestamp information to the record processing unit 254 in response to a request from the record processing unit 254. When the client 250 executes processing of the server for delivering recorded contents stored in the storing unit 251, the client-encryption processing unit 256 encrypts the contents stored in the storing unit 251 into a form suitable for output to the network and outputs the contents through the data transmitting and receiving unit 253.

In resuming recording after recovery from, for example, communication disconnection that occurs during reception of contents from the network tuner (the server) 200, the record processing unit 254 receives information concerning a value of a latest timestamp stored in the storing unit 251 from the client-encryption processing unit 256. The record processing unit 254 calculates, on the basis of this information, a value of a timestamp (a start timestamp value) that should be given to first transmission data (TTS) of the network tuner 200 after resumption of data transmission. The record processing unit 254 outputs a record streaming request in which the determined start timestamp value is recorded to the network tuner 200 through the data transmitting and receiving unit 253.

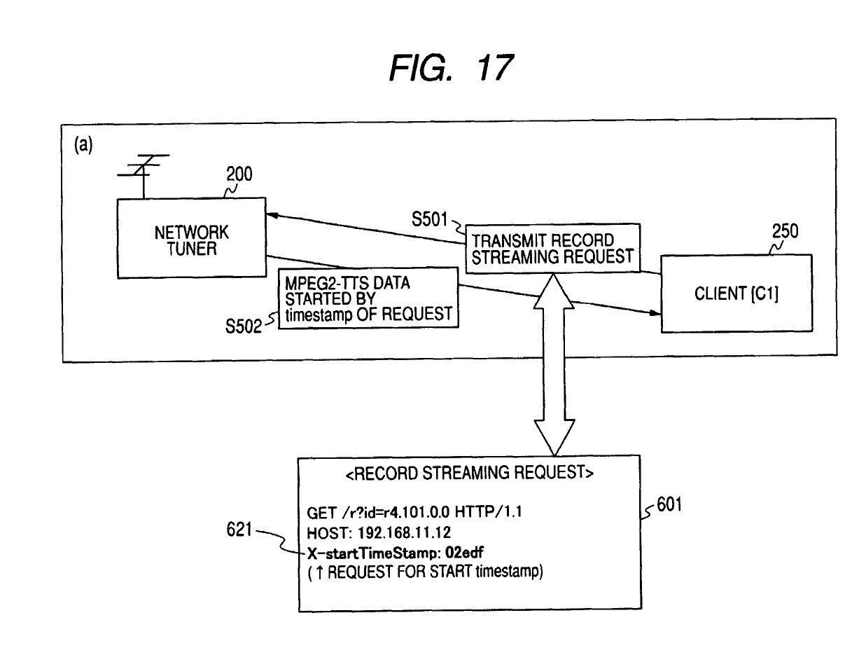

This processing is explained with reference to FIG. 17. (a) in FIG. 17 shows a communication processing sequence between the client 250 and the network tuner 200 for transmitting a request for resuming streaming delivery of recorded contents to the network tuner 200 after suspension of communication. First, in step S501, the client 250 outputs a request for resuming streaming delivery of recorded contents to the network tuner 200.

A specific example of data of the transmission resumption request is transmission resumption request data 601 shown in the figure. The data 601 is transmission data of HTTP GET in which a content URL is set. Setting information of the start timestamp value is described in a header of HTTP. In other words, on the basis of the latest timestamp value information stored in the storing unit 251 of the client 250, a start timestamp value 621, which is a value of a timestamp that should be given to first transmission data (TTS) of the network tuner 200 after resumption of data transmission, is recorded in the transmission resumption request data 601. Specifically, [X-startTimeStamp:02edf] is recorded.

The timestamp managing unit 207 of the network tuner 200 as a content provision server receives the transmission resumption request data 601 and receives the start timestamp value 621 included in the transmission resumption request data 601, i.e., a start timestamp value [02edf] of [X-startTimeStamp:02edf]. The timestamp managing unit 207 passes MPEG2-TTS data, which is created by adding a timestamp starting from the value [02edf] to the MPEG2-TS data received from the broadcast receiving unit 201, to the server-encryption processing unit 208. After encryption, the MPEG2-TTS data is outputted to the client 250 from the data transmitting and receiving unit 204.

In an example shown in FIG. 17, the setting information of the start timestamp value is described in the header of HTTP. The client 250 transmits a request “please start a timestamp of streaming data from 02edf (hexadecimal)” to the network tuner 200. The network tuner (the server) 200 receives this request and starts transmission of the MPEG2-TTS data starting with the start timestamp value [02edf].

In this way, continuity of a value of the timestamp set in the data (TTS) transmitted from the network tuner 200 to the client 250 in step S502 shown in FIG. 17 and a value of the timestamp set in the data stored in the storing unit 251 of the client 250 is maintained.

Usually, a start timestamp value that the client 250 requests the network tuner 200 to give to transmission data after recovery from a communication failure only has to be the “next” value continuing from a last timestamp value of data that the client-encryption processing unit 256 stored in the storing unit 251 up to that point.

However, on account of processing in the client-encryption processing unit 256, in some case, it is difficult to calculate a last timestamp value of recording data stored in the storing unit 251 and only a value sometime before the last timestamp value can be obtained. In such a case, it is also possible that the value is directly requested as the start timestamp value and data after the start timestamp value is discarded from the data stored in the storing unit 251.

In the embodiment described above, the network tuner 200 directly uses the start timestamp value, which is requested by the client 250 to be given to transmission data, as a value set in resumed transmission data. However, it is also possible that timestamp information notified from the client to the network tuner (the server) is set as a latest time stamp value received in the client, the next timestamp value continuing from the timestamp value is calculated in the server, and the calculated timestamp value is set in resumed transmission data.

According to this embodiment, there are advantages described below.

1. Since continuity of timestamps can be maintained during record processing in the client, when data encrypted and stored in the storing unit of the client is transferred to another client or the like, heavy-load work for resetting a timestamp is unnecessary.

2. In execution of record processing, simple processing of adding a requested start timestamp value to a header of an HTTP request (HTTP GET) transmitted from the client to the network tuner as a content transmission request is possible. The processing can be realized in a framework of an existing protocol.

The present invention has been explained in detail with reference to the specific embodiments. However, it is obvious that those skilled in the art can make various modifications and alterations of the embodiments without departing from the spirit of the present invention. The present invention has been disclosed in a form of illustration and should not be limitedly interpreted. To determine the gist of the present invention, the appended claims should be taken into account.

It is possible to execute the series of processing explained in the specification using hardware, software, or a combination of the hardware and the software. When processing by the software is executed, it is possible to install a program having a processing sequence recorded therein in a memory in a computer incorporated in dedicated hardware and cause the computer to execute the program. Alternatively, it is possible to install the program in a general-purpose computer that can execute various kinds of processing and cause the computer to execute the program.

For example, the program can be recorded in advance in a hard disk and a ROM (Read Only Memory) serving as recording media. Alternatively, the program can be temporarily or permanently stored (recorded) in a removable recording media such as a flexible disk, a CD-ROM (Compact Disc Read Only Memory), an MO (Magneto-optical) disk, a DVD (Digital Versatile Disc), a magnetic disk, and a semiconductor memory. Such removable recording media can be provided as so-called package software.

The program can be installed in the computer from the removable media. Besides, the program can be transferred from a download site to the computer by radio or transferred to the computer by wire through a network such as a LAN (Local Area Network) or the Internet. The computer can receive the program transferred in that way and install the program in a recording medium such as a hard disk built therein.

The various kinds of processing described in this specification is not only executed in time series in accordance with the above description but also may be executed in parallel or individually according a processing ability of an apparatus that executes the processing or according to necessity. The system in this specification is a logical set of plural apparatuses and is not limited to a system in which apparatuses of respective structures are stored in an identical housing.

As explained above, according to the embodiments of the present invention, in a communication system including a server that receives broadcast data and outputs the received data to a network-connected client and a client that performs reproduction or recording of the data received from the server, the server creates a record scheduling list based on record scheduling information inputted from the client and provides the client with the record scheduling list. The client executes an acquisition request for record-scheduled contents on the basis of the record scheduling information recorded in the record scheduling list. The server selects request data, for which content transmission processing is executed, from plural content acquisition request data overlapping in time, performs a content transmission permission response as a response to the selected request data and transmits requested contents, and performs a response indicating that a request is not executed as a response to the request data not selected. Therefore, the client only performs a content transmission request based on record scheduling set by the client itself without performing selection processing and the like for contents overlapping in time. Consequently, a processing load is reduced.

According to another embodiment of the present invention, record execution time determined by the server and present time information received by the broadcast receiving unit are recorded in record scheduling information and provided to the client. Therefore, an accurate content acquisition request based on these kinds of information is realized in the client.

According to still another embodiment of the present invention, it is possible to notify the server determined by the client of a value of a timestamp set by the server when suspension of communication or the like occurs between the server and the client. Therefore, continuity of timestamps is maintained and it is unnecessary to rewrite the set timestamp when the client acts as a server and transmits data. Consequently, a processing load is reduced.

It should be understood by those skilled in the art that various modifications, combinations, sub-combinations, and alterations may occur depending on design requirements and other factors insofar as they are within the scope of the appended claims or the equivalents thereof.

What is claimed is:

1. A communication system comprising:
a server that receives broadcast data and outputs the received data to a network-connected client; and
a client that performs reproduction or recording of the data received from the server, wherein
the server includes:
a broadcast receiving unit that receives the broadcast data; and
a server-record-scheduling-information managing unit that creates a record scheduling list based on record scheduling information inputted from the client,
the client includes:
a client-record-scheduling-information managing unit that acquires the record scheduling list from the server; and
a record processing unit that executes an acquisition request for record-scheduled contents on the basis of the record scheduling information recorded in the record scheduling list, and
the server-record-scheduling-information managing unit receives content acquisition request data from the network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

2. A communication system according to claim 1, wherein
the record processing unit of the client transmits a content acquisition request to the server on the basis of start scheduled time information of respective record-scheduled programs included in record scheduling information as recording data of the record scheduling list, and
the server-record-scheduling-information managing unit determines, by executing a selection algorithm set in advance, whether content transmission corresponding to the content acquisition request from the client should be executed.

3. A communication system according to claim 1, wherein the server-record-scheduling-information managing unit transmits, when the record scheduling list is updated, an update notice indicating that the record scheduling list is updated to the client.

4. A communication system according to claim 1, wherein
the server further includes an information-update monitoring unit that judges whether it is necessary to update the record scheduling list on the basis of a change in a broadcast time of broadcast contents, and
the server-record-scheduling-information managing unit performs, on the basis of judgment of the information-update monitoring unit that it is necessary to update the record scheduling list, processing for updating the record scheduling list.

5. A communication system according to claim 1, wherein the server-record-scheduling-information managing unit records, in the record scheduling list, broadcast start time information of a record-scheduled program and record execution start time information determined by the server.

6. A communication system according to claim 5, wherein the record processing unit of the client executes processing for determining timing for output of a content acquisition request to the server on the basis of the record execution start time information recorded in the record scheduling list.

7. A communication system according to claim 1, wherein
the server further includes a server-time-information managing unit that stores and manages present time information received by the broadcast receiving unit, and
the server-record-scheduling-information managing unit records the present time-information acquired by the server-time-information managing unit in the record scheduling list and provides the client with the present time information.

8. A communication system according to claim 7, wherein
the client further includes a client-time-information managing unit that calculates a difference between present time of the present time information recorded in the record scheduling list and time of a clock provided in the client, and
the record processing unit of the client performs processing for determining execution timing of record processing on the basis of time information corresponding to a record-scheduled program recorded in the record scheduling list and difference information provided from the client-time-information managing unit.

9. A communication system according to claim 1, wherein
the server further includes a timestamp managing unit that determines a value of a timestamp set in data transmitted to the client,
the client further includes a client-encryption processing unit that performs processing for decoding data received from the server and holds a value of a timestamp of data stored in a storing unit, and
the record processing unit of the client applies, in outputting a content transmission request after suspension of communication with the server, the value of the timestamp held by the client-encryption processing unit, determines a value of a timestamp set in data at the time of content transmission resumption in the server as a start timestamp value, and executes processing for notifying the server of the start timestamp value.

10. A communication system according to claim 9, wherein the timestamp managing unit of the server performs, on the basis of the start timestamp value included in the data received from the client, processing for determining a value of a timestamp set in transmission data after the suspension of the communication.

11. An information processing apparatus as a server that receives broadcast data and outputs the received data to a network-connected client, the information processing apparatus comprising:
a broadcast receiving unit that receives broadcast data; and
a server-record-scheduling-information managing unit that creates a record scheduling list based on record scheduling information inputted from the client, wherein
the server-record-scheduling-information managing unit receives content acquisition request data from a network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

12. An information processing apparatus according to claim 11, wherein the server-record-scheduling-information managing unit determines, by executing a selection algorithm set in advance, whether content transmission corresponding to the content acquisition request from the client should be executed.

13. An information processing apparatus according to claim 11, wherein the server-record-scheduling-information managing unit transmits, when the record scheduling list is updated, an update notice indicating that the record scheduling list is updated to the client.

14. An information processing apparatus according to claim 11, further comprising an information-update monitoring unit that judges whether it is necessary to update the record scheduling list on the basis of a change in a broadcast time of broadcast contents, wherein
the server-record-scheduling-information managing unit performs, on the basis of judgment of the information-update monitoring unit that it is necessary to update the record scheduling list, processing for updating the record scheduling list.

15. An information processing apparatus according to claim 11, wherein the server-record-scheduling-information managing unit records, in the record scheduling list, broadcast start time information of a record-scheduled program and record execution start time information determined by the server.

16. An information processing apparatus according claim 11, further comprising a server-time-information managing unit that stores and manages present time information received by the broadcast receiving unit, wherein
the server-record-scheduling-information managing unit records the present time formation acquired by the server-time-information managing unit in the record scheduling list and provides the client with the present time information.

17. An information processing apparatus according to claim 11, further comprising a timestamp managing unit that determines a value of a timestamp set in data transmitted to the client, wherein
the timestamp managing unit performs, on the basis of a start timestamp value included in data received from the client, processing for determining a value of a timestamp set in transmission data after the suspension of the communication.

18. An information processing apparatus as a client that receives broadcast data received by a server and performs reproduction or recording of the received data, the information processing apparatus comprising:
a client-record-scheduling-information managing unit that acquires a record scheduling list, which is created by the server on the basis of record scheduling information inputted from the client, from the server; and
a record processing unit that executes an acquisition request for record-scheduled contents on the basis of the record scheduling information recorded in the record scheduling list, wherein
the record processing unit transmits a content acquisition request to the server on the basis of start scheduled time information of respective record-scheduled programs included in record scheduling information as recording data of the record scheduling list.

19. An information processing apparatus according to claim 18, wherein
the record scheduling list created by the server has broadcast start time information of a record-scheduled program and record execution start time information determined by the server recorded therein, and
the record processing unit executes processing for determining timing for output of a content acquisition request to the server on the basis of the record execution start time information recorded in the record scheduling list.

20. An information processing apparatus according to claim 18, wherein
the record scheduling list created by the server has present time information received by a broadcast receiving unit of the server recorded therein,
the information processing apparatus includes a client-time-information managing unit that calculates a difference between present time of present time information recorded in the record scheduling list and time of a clock provided in the client, and
the record processing unit performs processing for determining execution timing of record processing on the basis of time information corresponding to a record-scheduled program recorded in the record scheduling list and difference information provided from the client-time-information managing unit.

21. An information processing apparatus according to claim 18, wherein further comprising a client-encryption processing unit that performs processing for decoding data received from the server and holds a value of a timestamp of data stored in a storing unit, wherein
the record processing unit applies, in outputting a content transmission request after suspension of communication with the server, the value of the timestamp held by the client-encryption processing unit, determines a value of a timestamp set in data at the time of content transmission resumption in the server as a start timestamp value, and executes processing for notifying the server of the start timestamp value.

22. An information processing method executed in an information processing apparatus as a server that receives broadcast data and outputs the received data to a network-connected client, the information processing method comprising:
a broadcast receiving step in which a broadcast receiving unit receives broadcast data;
a step in which a server-record-scheduling-information managing unit creates a record scheduling list based on record scheduling information inputted from the client; and
a step in which the server-record-scheduling-information managing unit receives content acquisition request data from a network-connected client, selects request data, for which content transmission processing is executed, from plural content acquisition request data overlapping in time, performs a content transmission permission response as a response to the selected request data and transmits requested contents, and performs a response indicating that a request is not executed as a response to the request data not selected.

23. An information processing method executed in an information processing apparatus as a client that receives broadcast data received by a server and performs reproduction or recording of the received data, the information processing method comprising:
a record-scheduling-information managing step in which a client-record-scheduling-information managing unit acquires a record scheduling list, which is created by the server on the basis of record scheduling information inputted from the client, from the server; and
a record processing step in which a record processing unit executes an acquisition request for record-scheduled contents on the basis of the record scheduling information recorded in the record scheduling list, wherein
the record processing step includes a step of transmitting a content acquisition request to the server on the basis of start scheduled time information of respective record-scheduled programs included in record scheduling information as recording data of the record scheduling list.

24. A computer program that causes an information processing apparatus as a server that receives broadcast data and outputs the received data to a network-connected client to execute information processing, the computer program causing the information processing apparatus to execute:
a broadcast receiving step of causing a broadcast receiving unit to receive broadcast data;
a step of causing a server-record-scheduling-information managing unit to create a record scheduling list based on record scheduling information inputted from the client; and
a step of causing the server-record-scheduling-information managing unit to receive content acquisition request data from the network-connected client, select request data, for which content transmission processing is executed, from plural content acquisition request data overlapping in time, perform a content transmission permission response as a response to the selected request data and transmit requested contents, and perform a response indicating that a request is not executed as a response to the request data not selected.

25. A computer program for causing an information processing apparatus as a client that receives broadcast data received by a server and performs reproduction and recording of the received data to execute information processing, the computer program causing the information processing apparatus to execute:
a record-scheduling-information managing step of causing a client-record-scheduling-information managing unit to acquire a record scheduling list, which is created by the server on the basis of record scheduling information inputted from the client, from the server; and
a record processing step of causing a record processing unit to execute an acquisition request for record-scheduled contents on the basis of the record scheduling information recorded in the record scheduling list, wherein
the record processing step includes a step of causing the information processing apparatus to transmit a content acquisition request to the server on the basis of start scheduled time information of respective record-scheduled programs included in record scheduling information as recording data of the record scheduling list.
